(19) United States
(12) Patent Application Publication
(10) Pub. No.: US 2011/0183110 A1
(43) Pub. Date: Jul. 28, 2011

(54) Optical film, antireflection film, polarizing plate and image display apparatus

(75) Inventors: Takayasu Yamazaki, Kanagawa (JP); Kenichi Fukuda, Kanagawa (JP); Miho Asahi, Kanagawa (JP); Jun Watanabe, Kanagawa (JP)

(73) Assignee: FUJIFILM Corporation, Tokyo (JP)

(21) Appl. No.: 12/929,063

(22) Filed: Dec. 28, 2010

(30) Foreign Application Priority Data
Dec. 28, 2009 (JP) P2009-298577

(51) Int. Cl. B32B 3/00; C08F 2/50; G02B 1/11; G02B 5/30; B32B 27/00; B32B 27/08

(52) U.S. Cl. 428/141; 427/508; 427/520; 359/601; 359/488.01; 428/500; 428/515; 428/336

(57) ABSTRACT

An optical film is provided and includes: a cellulose acylate film; and an antistatic layer including a conductive compound having a hydrophilic property. The conductive compound is localized in an inside of the antistatic layer as compared to a surface-side region of the antistatic layer.

This application is based on and claims priority under 35 U.S.C. §119 from Japanese Patent Application No. 2009-298577, filed Dec. 28, 2009, the entire disclosure of which is herein incorporated by reference.

### BACKGROUND OF THE INVENTION

1. Field of the Invention

The present invention relates to an optical film having an antistatic layer and to an antireflection film and a polarizing plate each using such an optical film, and further to an image display apparatus using at its topmost surface such an optical film, such an antireflection film or such a polarizing plate.

2. Background Art

On image display apparatuses such as a cathode-ray tube (CRT) display, a plasma display panel (PDP), an electroluminescent display (ELD), a vacuum fluorescent display (VFD), a field emission display (FED) or a liquid crystal display (LCD), it suits very well to provide a transparent hard coating film having antistatic properties for the purpose of preventing degradation caused in viewability by e.g. damage and dust adhesion to the display surface. In the case of a high-definition, highly-sophisticated image display apparatus, notably recent LCDs, it is also carried out to provide the image display apparatus with a transparent antireflection film having antistatic properties or the like for the purpose of preventing a contrast drop caused by reflections of outside light from the display surface and surroundings' reflection in the image display apparatus in addition to the dust-preventive purpose.

Such an optical film is generally used as a surface film of a polarizer (a protective film for use in a polarizing plate) and, when a substrate of the protective film is a cellulose acylate film, the cellulose acylate film surface on the side opposite to the side where optically functional layers are provided, or on the side where a polarizer is stuck, can be rendered hydrophilic, and thereby adhesiveness to the polarizer can be improved.

Such treatment to render the substrate surface hydrophilic refers to as saponification treatment, and the treatment is generally performed using e.g. a method of immersing a substrate in an alkali solution of a concentration of 1 mol/L or higher and then subjecting the substrate to neutralization with an acid solution. According to this method, the surface on the side where optically functional layers are provided is also exposed to the alkali solution, and thereby there has sometimes occurred the case where the optically functional layers suffer damage to their functions themselves. For example, in the case of an antistatic film incorporating a conductive compound for the purpose of imparting antistatic properties to the film, there has been an occurrence that the conductive compound loses its conductivity by being exposed to an alkali solution and fails to serve the intended function. For optical films having antistatic properties, it is therefore highly important to suffer no reduction in conductivity through alkali solution treatment, namely to have high chemical resistance. Thus it has been strongly desired to develop arts of achieving retention of the intended functions.

On the other hand, JP-A-2009-263567, JP-A-2005-316428, JP-A-2009-86660, and JP-A-2003-39619 disclose the techniques on optical films wherein the use of e.g. compounds having quaternary ammonium bases is adopted as a method for imparting antistatic properties to optical films. In these documents, there are descriptions of useful techniques, such as the techniques of developing stable and satisfactory conductivity and the techniques of not only improving surface conditions, conductivity and adhesiveness after high-temperature high-humidity testing but also reducing interference unevenness.

In the optical films disclosed in JP-A-2009-263567, JP-A-2005-316428, and JP-A-2009-86660, however, the compounds having quaternary ammonium bases are localized to surface neighborhood of the films in a concentrated condition, and therefore alterations in quality of the compounds having quaternary ammonium bases occur e.g. when immersion of the optical films in an alkali solution or the like is performed as treatment for rendering their substrates hydrophilic, and thereby reduction in conductivity is caused. In other words, those optical films offer no solutions to an issue of chemical resistance.

In addition, although it is disclosed in JP-A-2003-39619 that the optical film having excellent smoothness and slipping property can be obtained by specifying the nitrogen atom content in surface part of the antistatic film having a surface coating, JP-A-2003-39619 foresees no techniques on chemical resistance. This being the case, it is conceivable that the antistatic film won't have sufficient chemical resistance.

### SUMMARY OF THE INVENTION

An object of an illustrative, non-limiting embodiment of the invention is to provide an optical film which excels in chemical resistance as well as antistatic properties.

Another object is to provide a method for making optical films which excel in chemical resistance as well as antistatic properties.

A further object is to provide an antireflection film, a polarizing plate and image display apparatus which each incorporate such an optical film as mentioned above.

As a result of our intensive studies for achieving the objects, it has been found that the objects can be solved and attained by providing on a cellulose acylate film an antistatic layer which contains a conductive compound having a hydrophilic property, and further by adjusting distribution of the conductive compound in the antistatic layer to fall within a specified range, and thus the invention has been achieved.

[1] An optical film comprising:

a cellulose acylate film; and

an antistatic layer including a conductive compound having a hydrophilic property,

wherein the conductive compound is localized in an inside of the antistatic layer as compared to a surface-side region of the antistatic layer.

[2] The optical film as described in [1], wherein the conductive compound is an ion-conducting compound or an electron-conducting compound.
[3] The optical film as described in [1] or [2], wherein the conductive compound is an ion-conducting compound having a quaternary ammonium base.
[4] The optical film as described in [3], wherein the compound having a quaternary ammonium base is a polymer having at least one of structural units represented by formulae (I) to (III):

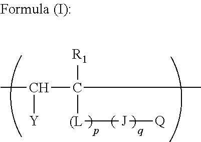

wherein R₁ represents a hydrogen atom, an alkyl group, a halogen atom or —CH₂COO⁻M⁺; Y represents a hydrogen atom or —COO⁻M⁺; M⁺ represents a proton or a cation; L represents —CONH—, —COO—, —CO— or —O—; J represents an alkylene group or an arylene group; each of p and q independently represents 0 or 1 and Q represents one selected from the following group

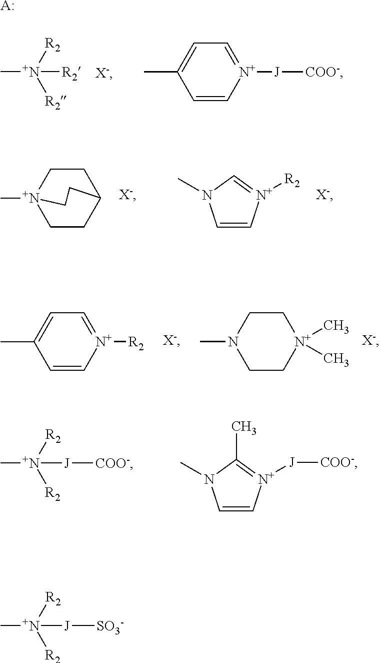

wherein each of R₂s, R₂′ and R₂″ independently represents an alkyl group; each J represents an alkylene group or an arylene group; and each X″ represents an anion,

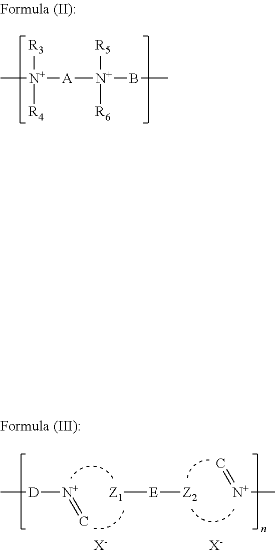

wherein each of R₃, R₄, R₅ and R₆ independently represents an alkyl group; R₃ and R₄ may bond to each other to form a nitrogen-containing heterocyclic ring and R₅ and R₆ may bond to each other to form a nitrogen-containing heterocyclic ring; each of A, B and D independently represents an alkylene group, an arylene group, an alkenylene group, an arylenealkylene group, —R₇COR₈—, —R₉COOR₁₀OCOR₁₁—, —R₁₂OCR₁₃COOR₁₄—, —R₁₅—(OR₁₆)ₘ—, —R₁₇CONHR₁₈NHCOR₁₉—, —R₂₀OCONHR₂₁NHCOR₂₂— or —R₂₃NHCONHR₂₄NHCONHR₂₅—; E represents a single bond, an alkylene group, an arylene group, an alkenylene group, an arylenealkylene group, —R₇COR₃—, —R₉COOR₁₀OCOR₁₁—, —R₁₂OCR₁₃COOR₁₄—, —R₁₅—(OR₁₆)ₘ—, —R₁₇CONHR₁₈NHCOR₁₉—, —R₂₀OCONHR₂₁NHCOR₂₂—, —R₂₃NHCONHR₂₄NHCONHR₂₅— or —NHCOR₂₆CONH—; each of R₇, R₈, R₉, R₁₁, R₁₂, R₁₄, R₁₅, R₁₆, R₁₇, R₁₉, R₂₀, R₂₂, R₂₃, R₂₅ and R₂₆ represents an alkylene group; each of R₁₀, R₁₃, R₁₈, R₂₁ and R₂₄ independently represents a linkage group selected from an alkylene group, an alkenylene group, an arylene group, an arylenealkylene group or an alkylenearylene group; m represents a positive integer of 1 to 4; X″ represents an anion; each of Z₁ and Z₂ represents nonmetal atoms required for forming a 5- or 6-membered ring together with the group —N═C—, which may link with E in a form of a quaternary salt ≡N⁺[X³¹]—; and n represents an integer of 5 to 300.
[5] The optical film as described in [3] or [4], wherein the antistatic layer has a nitrogen or sulfur atom content of 0.5 mol % to 5 mol % in the surface-side region, wherein the content is determined by elementary analysis by means of ESCA.
[6] The optical film as described in any one of [3] to [5], characterized in that the antistatic layer has a nitrogen or sulfur atom content distribution satisfying expression (1), wherein the content is determined by elementary analysis by means of ESCA:

β/α>2.5 Expression (1):

wherein α and β are nitrogen or sulfur atom contents determined by the elementary analysis of the antistatic layer; and when a total nitrogen or sulfur atom content of the antistatic layer is taken as 100 mol %, α represents a nitrogen or sulfur atom content in the surface-side region of the antistatic layer and β represents a nitrogen or sulfur atom content in a cellulose acylate film-side region of the antistatic layer.
[7] The optical film as described in any one of [1] to [6], which has a total haze of from 0.1% to lower than 1% and an arithmetic mean roughness Ra according to JIS B0601 of 0.03 μm.
[8] The optical film as described in any one of [1] to [7], wherein the antistatic layer has a thickness of 6 μm to 20 μm.
[9] The optical film as described in any one of [1] to [8], wherein the antistatic layer is a layer formed by curing a composition containing the conductive compound, a multifunctional monomer having two or more polymerizable groups, a photopolymerization initiator and a carbonate solvent represented by formula (IV) or (V):

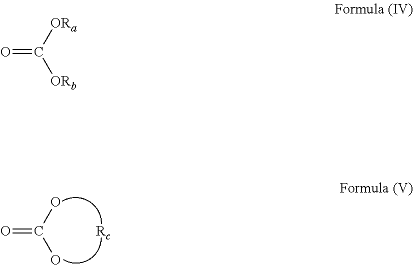

wherein each of Ra and Rb independently represents an alkyl group, and Rc represents an alkylene group.
[10] The optical film as described in [9], wherein the polymerizable group of the multifunctional monomer is a group selected from an acryloyl group, a methacryloyl group or —C(O)OCH═CH₂.
[11] A method for producing an optical film including a cellulose acylate film and an antistatic layer, the method comprising:

coating on the cellulose acylate film a composition including a conductive compound having a hydrophilic property, a multifunctional monomer having two or more polymerizable groups, a photopolymerization initiator, and a carbonate solvent represented by formula (IV) or (V); and

curing the composition coated, to form the antistatic layer:

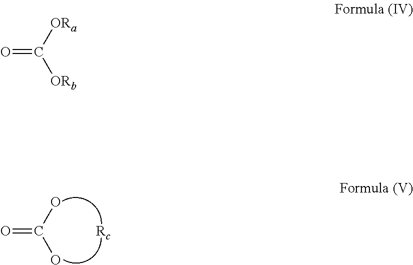

wherein each of Ra and Rb independently represents an alkyl group, and Rc represents an alkylene group.
[12] The method for producing the optical film as described in [11], wherein the conductive compound is an ion-conducting compound or an electron-conductive compound.
[13] The method for producing the optical film as described in [11] or [12], wherein the conductive compound is an ion-conducting compound having a quaternary ammonium base.
[14] The method for producing the optical film as described in [13], wherein the compound having a quaternary ammonium base is a polymer having at least one of the structural units represented by the formulae (I) to (III) described in [4].
[15] An antireflection film comprising: an optical film described in any one of [1] to [10]; and a low refractive-index layer having a lower refractive index than that of the antistatic layer.
[16] A polarizing plate comprising: a polarizer; and two protective films on respective sides of the polarizer, wherein at least one of the two protective films is an optical film described in any one of [1] to [10] or an antireflection film described in [15].
[17] An Image display apparatus comprising an optical film described in any one of [1] to [10], an antireflection film described in [15], or a polarizing plate described in [16].

### DETAILED DESCRIPTION OF THE INVENTION

According to an exemplary embodiment of the invention, it is possible to provide an optical film which has a sufficient antistatic power and excels in chemical resistance, and further to provide an antireflection film, a polarizing plate and image display apparatus which each incorporate such an optical film.

Exemplary embodiments of the invention are explained below in detail, but the invention should not be construed as being limited to these modes. Incidentally, when numerical values express values of physical properties, characteristic values or the like in this specification, the mention of “(numerical value 1) to (numerical value 2)” denotes “(numerical value 1) or more and (numerical value 2) or less”. In addition, the wording “(meth)acrylate” in this specification denotes “at least either acrylate or methacrylate”. The wordings “(meth)acrylic acid” and “(meth)acryloyl” have the same denotations as the above.

An optical film according to an exemplary embodiment of the invention has on a cellulose acylate film an antistatic layer containing a conductive compound having hydrophilic properties, and the conductive compound is localized in an inside of the antistatic layer as compared to a surface-side region of the antistatic layer.

In the antistatic layer, as described above, a specific conductive compound is localized to the cellulose acylate film side, and thereby the optical film having excellent antistatic properties and high chemical resistance is obtained.

The expression of “a surface-side region” of the antistatic layer as used in this specification means the region lying on the side opposite to the cellulose acylate film side and in proximity to the topmost surface of the antistatic layer, and more specifically, refers to the region extending from a depth of 0 to a depth of 0.5 μm below the topmost surface of the antistatic layer.

The expression of “a region on the cellulose acylate film side” (hereinafter referred to as “a substrate-side region” too) as used in this specification means a region other than “the surface-side region of the antistatic layer” in the antistatic layer, and more specifically, refers to the region extending from a depth of 0.5 μm to a depth of 1 μm below the topmost surface of the antistatic layer.

In the present optical film, the conductive compound is localized in the inside rather than “the surface-side region” of the antistatic layer. The expression of “the conductive compound is localized in the inside of the antistatic layer” in this specification means that the conductive compound is present in a greater amount in “the region on the cellulose acylate film side” than in “the surface-side region”. The ratio of the amount of the conductive compound present in the region on the cellulose acylate film side to the amount of the conductive compound present in the surface-side region is preferably 2.5 or higher.

The amount in which the conductive compound is present can be estimated by measuring the amount of nitrogen or sulfur atoms present in the antistatic layer. In the antistatic layer, the ratio of the amount of nitrogen or sulfur atoms in “the region on the cellulose acylate film side” to the amount of nitrogen or sulfur atoms in “the surface-side region” is preferably 2.5 or higher.

The localization of the conductive compound can be achieved by choosing the kind and amount of a solvent used for forming the antistatic layer or by controlling the concentration of an antistatic coating solution. However, the method of using a particular hydrophilic solvent is preferred in point of not only easiness with which the conductive compound specified by the invention is localized but also feasibility of improving surface conditions.

Although detailed reasons why the conductive compound is easy to localize when a hydrophilic solvent is used are not found yet, the easy localization of the conductive compound is thought to be attributable to high affinity of the conductive compound for the hydrophilic solvent because of their hydrophilic properties, and further to attraction of the conductive compound towards the cellulose acylate film (substrate) interface through the affinity of the conductive compound for the solvent when the solvent has a high substrate solubility (cellulose acylate film solubility). Therefore a solvent having hydrophilic properties and high substrate solubility allows in theory localization of the conductive compound to the inside of the antistatic layer, and formation of an optical film having excellent chemical resistance becomes possible. However, depending on the kind of a solvent used, there may be cases where localization of conductive compounds is not attained. As mentioned hereinafter, use of particular carbonate solvents is preferred in the invention.

Additionally, in the antistatic layer of the present optical film, the conductive compound, though localized to the inside rather than “surface-side region”, is present throughout the antistatic layer, and no interface between the layer in which the conductive compound is present and the layer in which the conductive compound is absent is present on the inside of the antistatic layer.

The present optical film is further explained below.

### (Layer Structure of Optical Film)

The present optical film has an antistatic layer on a cellulose acylate film, and further may have required functional layers in a single- or multiple-layer form in response to its end-use purpose. For instance, the optical film can have a hard coating layer for the purpose of heightening the physical strength thereof, or the optical film can have a multilayer structure formed so as to cause a decrease in reflectivity by optical interference with consideration given to the refractive index and thickness of each layer, the arranging order and number of layers, and so on.

Examples of a more specific layer structure of the present optical film are given below. Incidentally, the transparent substrate in each of the following examples stands for a cellulose acylate film.

Transparent substrate/antistatic layer
Transparent substrate/antistatic layer/low refractive-index layer
Transparent substrate/antistatic layer/hard coating layer
Transparent substrate/antistatic layer/antiglare layer
Transparent substrate/antistatic layer/high refractive-index layer/low refractive-index layer
Transparent substrate/antistatic layer/medium refractive-index layer/high refractive-index layer/low refractive-index layer
Transparent substrate/antistatic layer/hard coating layer/low refractive-index layer
Transparent substrate/antistatic layer/antiglare layer/low refractive-index layer
Transparent substrate/antistatic layer/hard coating layer/medium refractive-index layer/high refractive-index layer/low refractive-index layer

### <Cellulose Acylate Film>

The present optical film uses a cellulose acylate film as its transparent substrate (base material).

The transparent substrate has no particular restrictions so long as it is a cellulose acylate film. However, when the optical film is set on a display, a cellulose triacetate film is used to particular advantage in terms of productivity and cost, because it can be used as-is as the protective film covering the polarizing layer of a polarizing plate. The thickness of a cellulose acylate film, though usually on the order of 25 μm to 1,000 μm, is preferably from 40 μm to 200 μm from the viewpoint of ensuring easy handling and required substrate strength.

As the cellulose acylate film in the invention, it is advantageous to use a cellulose acetate film having an acetylation degree of 59.0% to 61.5%. The term acetylation degree refers to the combined acetate content based on the mass of a cellulose unit. The acetylation degree is determined in accordance with the acetylation degree measurement and calculation in ASTM: D-817-91 (method for testing cellulose acetate or the like). The viscosity-average degree of polymerization (DP) of cellulose acylate is preferably 250 or above, far preferably 290 or above.

And it is preferable that the cellulose acylate used in the invention is close to 1.0 in its Mw/Mn value (wherein Mw stands for mass-average molecular weight and Mn stands for number-average molecular weight) determined by gel permeation chromatography, in other words, narrow in molecular weight distribution. The concrete value of Mw/Mn is preferably from 1.0 to 1.7, far preferably from 1.3 to 1.65, especially preferably from 1.4 to 1.6.

In general the total substitution degree in cellulose acylate is not distributed evenly among hydroxyl groups at 2-, 3- and 6-positions on a ⅓-to-⅓ basis, but the degree of substitution for the 6-position hydroxyl group tends to be lower. However, it is preferred in the invention that the degree of substitution for the 6-position hydroxyl group be higher than those for the 2- and 3-position hydroxyl groups.

More specifically, it is preferred that the degree of substitution of an acyl group for the 6-position hydroxyl group account for 32% or more, preferably 33% or more, especially 34% or more, of the total substitution degree. Moreover, it is preferred that the substitution degree of the 6-position acyl group in cellulose acylate be 0.88 or higher. The 6-position hydroxyl group may be substituted with an acyl group other than an acetyl group, namely an acyl group having a carbon number of 3 or greater, such as a propionyl group, a butyroyl group, a valeroyl group, a benzoyl group or an acryloyl group. The substitution degree at each position can be determined by NMR measurement.

As the cellulose acylate in the invention, the cellulose acetate products obtained by using the methods disclosed in JP-A 11-5851, paragraph Nos. 0043 to 0044, Example and Synthesis Example 1, paragraph Nos. 0048 to 0049, Synthesis Example 2, and paragraph Nos. 0051 to 0052, Synthesis Example 3, can be used.

### <Antistatic Layer>

The antistatic layer of the present optical film contains a conductive compound having hydrophilic properties.

By the use of a conductive compound having hydrophilic properties, the conductive compound can be localized to a substrate-side region, and hereby can improve chemical resistance.

For the purpose of imparting hydrophilic properties to a conductive compound, a hydrophilic group may be introduced into the conductive compound. From the viewpoint of developing high conductivity and being available at a relatively low price, it is preferred that the conductive compound have a cationic group, especially a quaternary ammonium base.

### (Conductive Compound)

The conductive compound used in the invention has no particular restrictions so long as it has hydrophilic properties, and examples thereof include ion-conducting compounds and electron-conducting compounds.

Examples of an ion-conducting compound include cationic, anionic, nonionic and amphoteric ion-conducting compounds. Examples of an electron-conducting compound include non-conjugated or conjugated macromolecular electron-conducting compounds which each contain aromatic carbon or heterocyclic rings interlinked with one another via single bonds or di- or higher-valent linkage groups.

Of these conducting compounds, compounds having quaternary ammonium bases (cationic compounds) are preferred over the others in terms of high antistatic power, relatively low prices and localization to the substrate-side region.

Although the compounds having quaternary ammonium bases may be either those of high molecular type or those of low molecular type, cationic antistatic agents of high molecular type are preferably used because they don't cause changes in antistatic properties by bleedout or so on.

As the quaternary ammonium base-containing cationic compounds of high molecular type, those selected from known compounds as appropriate can be used. In point of localization to the substrate-side region, however, polymers which each have at least one of structural units represented by the following formulae (I) to (III) are used to advantage.

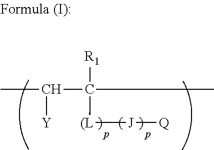

In the formula (I), R₁ represents a hydrogen atom, an alkyl group, a halogen atom or —CH₂COO⁻M⁺, Y represents a hydrogen atom or —COO⁻M⁺, M⁺ represents a proton or a cation, L represents —CONH—, —COO—, —CO— or —O—, J represents an alkylene group or an arylene group, and Q represents one selected from the group A.

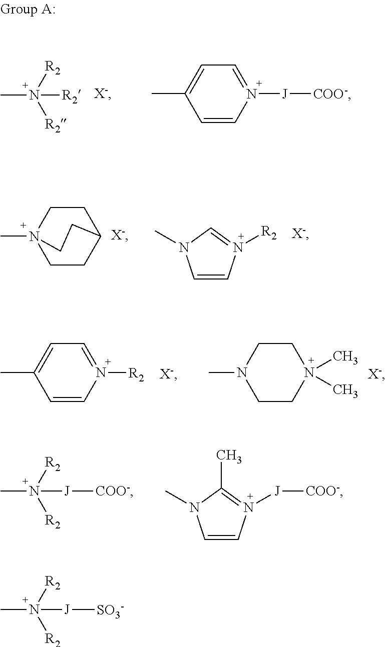

In the above formulae, each of R₂s, R₂′ and R₂″ independently represents an alkyl group, each J represents an alkylene group or an arylene group, and each X⁻ represents an anion. Each of p and q independently represents 0 or 1.

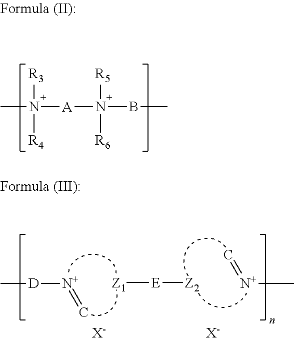

In the formulae (II) and (III), each of R₃, R₄, R₅ and R₆ independently represents an alkyl group or each of the R₃-R₄ pair and the R₅-R₆ pair may form a bond and complete a nitrogen-containing heterocyclic ring, each of A, B and D independently represents an alkylene group, an arylene group, an alkenylene group, an arylenealkylene group, —R₇COR₈—, —R₉COOR₁₀OCOR₁₁—, —R₁₂OCR₁₃COOR₁₄—, —R₁₅—(OR₁₆)ₘ—, —R₁₇CONHR₁₈NHCOR₁₉—, —R₂₀OCONHR₂₁NHCOR₂₂— or —R₂₃NHCONHR₂₄NHCONHR₂₅—, E represents a single bond, an alkylene group, an arylene group, an alkenylene group, an arylenealkylene group, —R₇COR₈—, —R₉COOR₁₀OCOR₁₁—, —R₁₂OCR₁₃COOR₁₄—, —R₁₅—(OR₁₆)ₘ—, —R₁₇CONHR₁₈NHCOR₁₉—, —R₂₀OCONHR₂₁NHCOR₂₂—, —R₂₃NHCONHR₂₄NHCONHR₂₅— or —NHCOR₂₆CONH—, each of R₇, R₈, R₉, R₁₁, R₁₂, R₁₄, R₁₅, R₁₆, R₁₇, R₁₉, R₂₀, R₂₂, R₂₃, R₂₅ and R₂₆ represents an alkylene group, each of R₁₀, R₁₃, R₁₈, R₂₁ and R₂₄ independently represents a linkage group selected from an alkylene group, an alkenylene group, an arylene group, an arylenealkylene group or an alkylenearylene group, m represents a positive integer of 1 to 4, X″ represents an anion, each of Z₁ and Z₂ represents nonmetal atoms required for completing a 5- or 6-membered ring together with the group —N═C—, which may link with E in the form of a quaternary salt ≡N⁺[X⁻]—, and n represents an integer of 5 to 300.

Explanations of substituents in the formulae (I) to (III) are given below.

The halogen atom is a chlorine atom or a bromine atom, preferably a chlorine atom.

The alkyl group is preferably a branched or straight-chain alkyl group having a carbon number of 1 to 4, far preferably a methyl group, an ethyl group or a propyl group.

The alkylene group is preferably an alkylene group having a carbon number of 1 to 12, far preferably a methylene group, an ethylene group or a propylene group, particularly preferably an ethylene group.

The arylene group is preferably an arylene group having a carbon number of 6 to 15, far preferably a phenylene group, a diphenylene group, a phenylmethylene group, a phenyldimethylene group or a naphthylene group, particularly preferably a phenylmethylene group. These groups may have substituents.

The alkenylene group is preferably an alkenylene group having a carbon number of 2 to 10, and the arylenealkylene group is preferably an arylenealkylene group having a carbon number of 6 to 12. These groups may have substituents.

Examples of a substituent the foregoing groups each may have include a methyl group, an ethyl group and a propyl group.

In the formula (I), R₁ is preferably a hydrogen atom, Y is preferably a hydrogen atom, J is preferably a phenylmethylene group, Q is preferably a group selected from the class A and represented by the following formula (VI) wherein each of R₂, R₂′ and R₂″ is a methyl group, X⁻ is e.g. a halide ion, a sulfonate anion or a carboxylate anion, preferably a halide ion, far preferably a chloride ion, and each of p and q is preferably 0 or 1 and the case of p=0 and q=1 is far preferred.

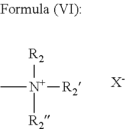

In the formulae (II) and (III), each of R₃, R₄, R₅ and R₆ is preferably a substituted or unsubstituted alkyl group having a carbon number of 1 to 4, far preferably a methyl group or an ethyl group, particularly preferably a methyl group, each of A, B and D independently represents preferably a substituted or unsubstituted alkylene, arylene, alkenylene or arylenealkylene group having a carbon number of 2 to 10, far preferably a phenyldimethylene group, X⁻ is e.g. a halide ion, a sulfonate anion or a carboxylate anion, preferably a halide ion, far preferably a chloride ion, E is preferably a single bond, an alkylene group, an arylene group, an alkenylene group or an arylenealkylene group, and an example of the 5- or 6-membered ring each of Z₁ and Z₂ forms together with the group —N═C— is a diazoniabicyclooctane ring.

Examples of a compound having structural units represented by the formula (I), (II) or (III) are illustrated below, but the invention should not be construed as being limited by these examples. Additionally, among the subscripts (m, x, y, r and real numeric values) in the following examples, m stands for the number of repetitions of each unit, and x, y and r stand for mole fractions of the units concerned, respectively.

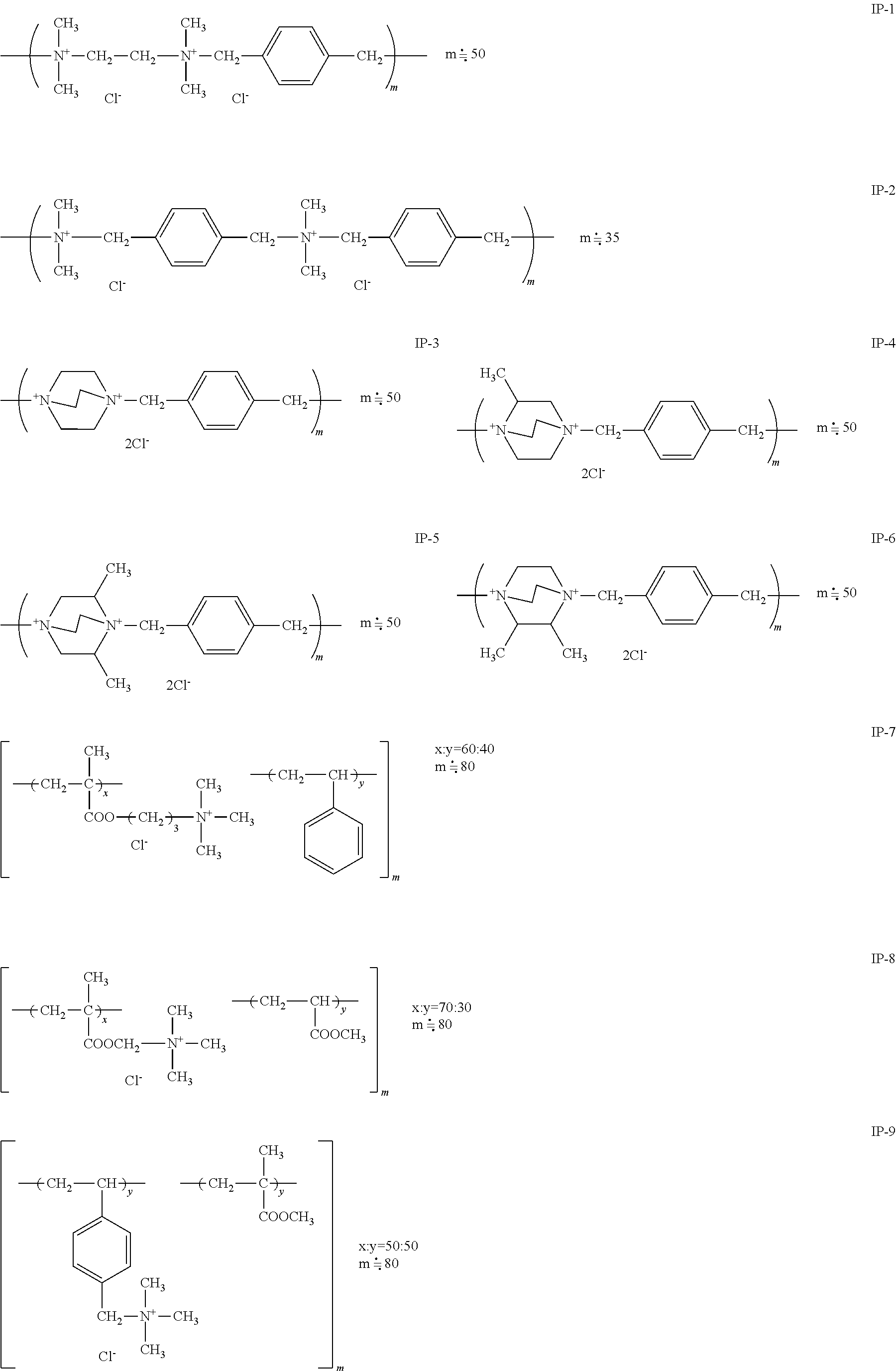

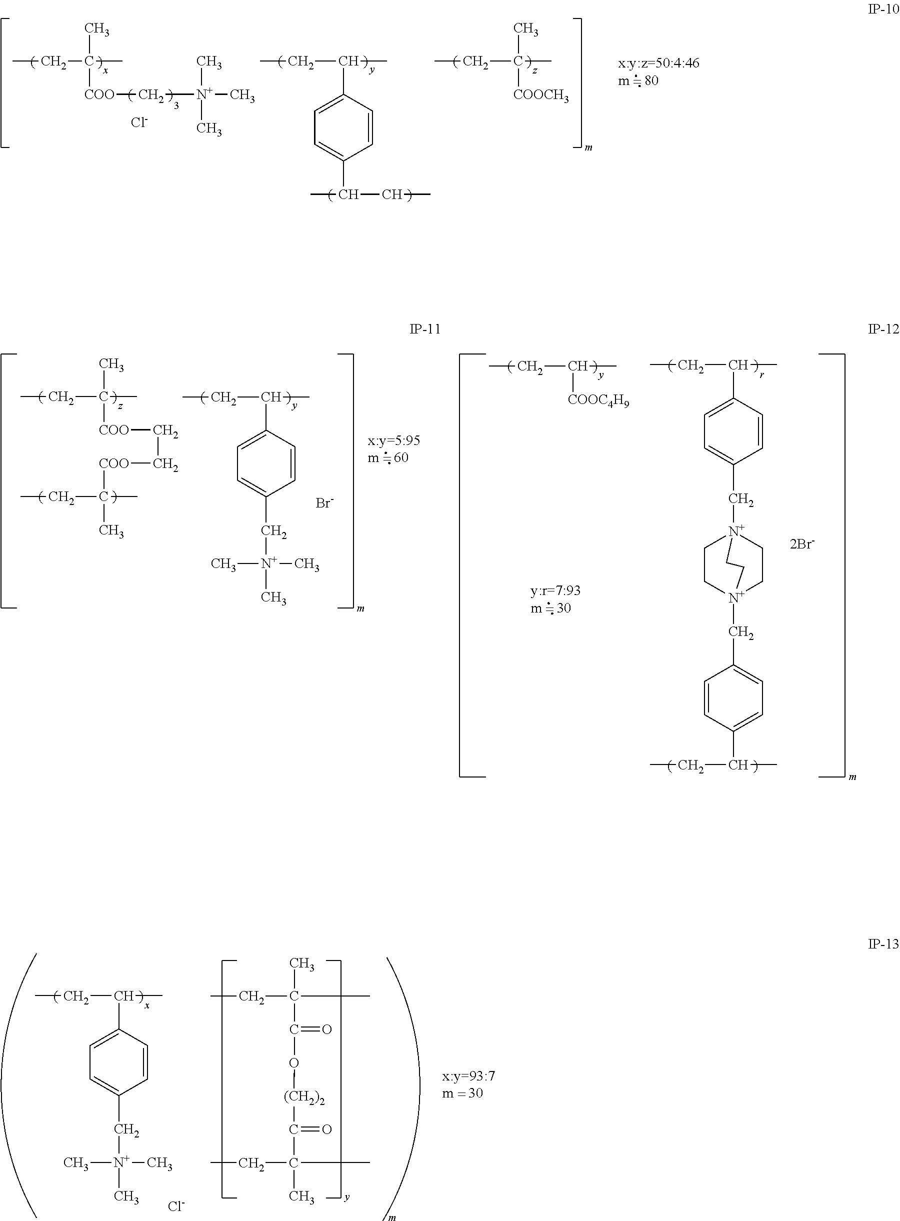

The conductive compounds illustrated above may be used alone, or can be used as combinations of two or more thereof. In addition, antistatic compounds having polymerizable groups within molecules of antistatic agents are far preferred because they can also enhance scratch resistance (film strength) of the antistatic layer.

Electron-conducting compounds are preferably non-conjugated or conjugated high polymers in each of which aromatic carbon or heterocyclic rings are interlinked with one another via single bonds or di- or higher-valent linkage groups. An example of the aromatic carbon rings in each non-conjugated or conjugated high polymer is a benzene ring, and the benzene ring may further form a fused ring. Examples of the aromatic heterocyclic rings in each non-conjugated or conjugated high polymer include a pyridine ring, a pyrazine ring, a pyrimidine ring, a pyridazine ring, a triazine ring, an oxazole ring, a thiazole ring, an imidazole ring, an oxadiazole ring, a thiadiazole ring, a triazole ring, a tetrazole ring, a furan ring, a thiophene ring, a pyrrole ring, an indole ring, a carbazole ring, a benzimidazole ring and an imidazopyridine ring. These rings each may further form a fused ring, and may have a substituent.

Examples of the di- or higher-valent linkage groups in each non-conjugated or conjugated high polymer include linkage groups formed from carbon atoms, silicon atoms, nitrogen atoms, boron atoms, oxygen atoms, sulfur atoms, metals, metal ions or/and so on, preferably groups formed from carbon atoms, nitrogen atoms, silicon atoms, boron atoms, oxygen atoms, sulfur atoms, or combinations of these atoms. Examples of groups formed from the combinations include a substituted or unsubstituted methylene group, a carbonyl group, an imido group, a sulfonyl group, a sulfinyl group, an ester group, an amido group and a silyl group.

Examples of such an electron-conducting compound include substituted or unsubstituted conductive polyaniline, poly(p-phenylene), poly(p-phenylenevinylene), polythiophene, polyfuran, polypyrrole, polyselenophene, polyisothianaphthene, polyphenylene sulfide, polyacetylene, polypyridylvinylene, polyazine, and derivatives of these polymers. These high molecular compounds may be used alone, or as combinations of two or more thereof in response to the purposes of using them.

Those conductive polymers may be used as mixtures with polymers having no conductivity so long as the mixtures can attain the intended conductivity. Alternatively, copolymers of monomers capable forming conductive polymers and other monomers having no conductivity may be used.

It is far preferred that the electron-conducting compounds be conjugated high polymers. Examples of a conjugated high polymer include polyacetylene, polydiacetylene, poly(p-phenylene), polyfluorene, polyazurene, poly(p-phenylene sulfide), polypyrrole, polythiphene, polyisothianaphthene, polyaniline, poly(p-phenylenevinylene), poly(2,5-thienylenevinylene), double-chain conjugated high polymers (such as polyperinaphthalene), metal phthalocyanine series high polymers, other conjugated high polymers (such as poly(p-xylene) and poly[α-(5,5′-bithiophenediyl)benzylidene]), and derivatives thereof. Of these polymer, poly(p-phenylene), polypyrrole, polythiophene, polyaniline, poly(p-phenylenevinylene) and poly(2,5-thienylenevinylene) are preferable to the others, polythiophene, polyaniline, polypyrrole and derivatives of these polymers are far preferred, and at least either polythiophene or a derivative thereof is further preferred.

Examples of those electron-conducting compounds are illustrated below, but the invention should not be construed as being limited by these examples. In addition to these compounds, the compounds disclosed in WO 98/01909 can also be included in such examples.

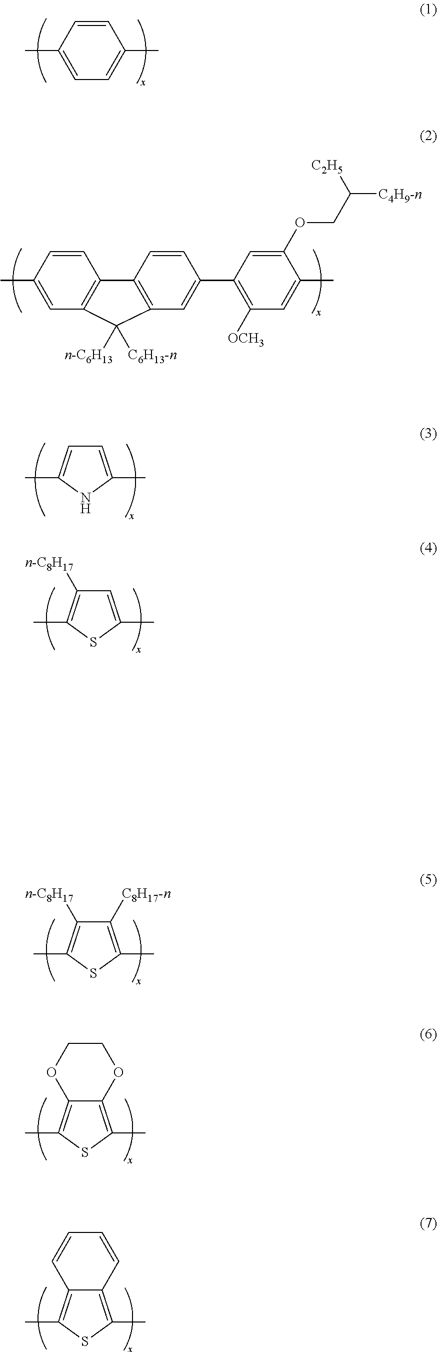

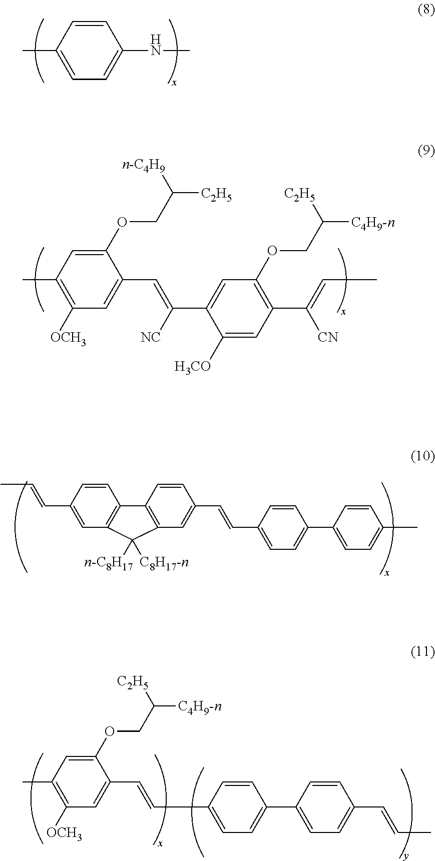

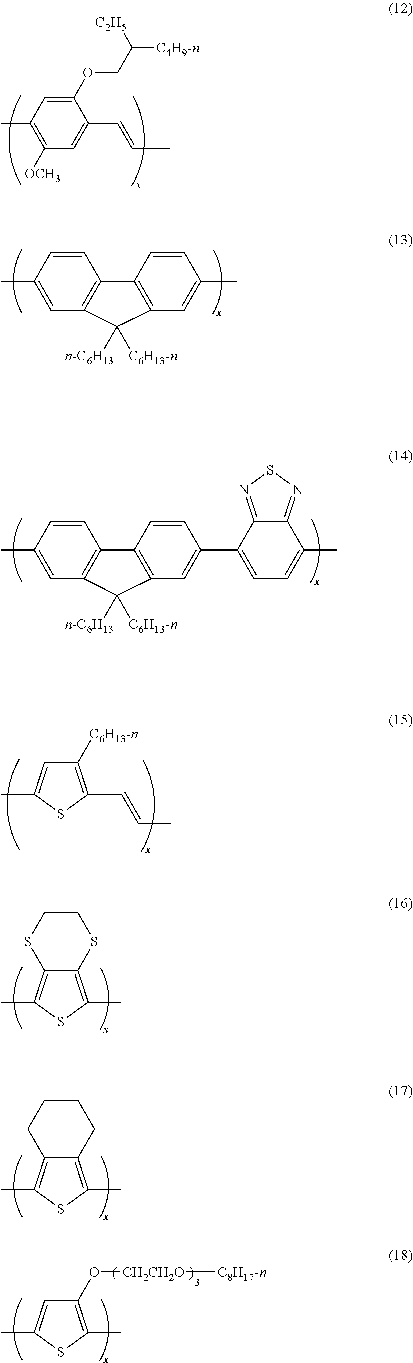

The mass-average molecular weight of electron-conducting compounds usable in the invention is preferably from 1,000 to 1,000,000, far preferably from 10,000 to 500,000, further preferably from 10,000 to 100,000. The term mass-average molecular weight used herein refers to the mass-average molecular weight measured by gel permeation chromatography and calculated in terms of polystyrene.

From the viewpoint of ensuring coating suitability and affinity for other ingredients, it is appropriate that the electron-conducting compounds used in the invention be soluble in organic solvents. The word “soluble” used herein refers to the state in which single molecules are dissolved in a solvent separately or in a condition that a plurality of single molecules are associated, or the state in which particles 300 nm or below in size are dispersed in a solvent.

Electron-conducting compounds generally have hydrophilic properties since they are soluble in solvents with water as their main ingredient. In order to dissolve such electron-conducting compounds in organic solvents, compounds capable of enhancing affinity for organic solvents (e.g. solubilization assistants) or dispersants suitable for use in organic solvents are added to or polyanion dopants having undergone hydrophobicity-imparting treatment are used in compositions containing electron-conducting compounds. By the use of such a method, electron-conducting compounds become soluble in the organic solvents specified in the invention; still, they retain hydrophilic properties as a whole, and can be localized as conductive compounds by applying thereto the present method.

When the conductive compound used is a compound having a quaternary ammonium base, the nitrogen or sulfur atom content in the surface-side of the antistatic layer is preferably from 0.5 mol % to 5 mol %, as determined by elemental analysis using electron spectroscopy for chemical analysis (referred to as ESCA). In such a content range, satisfactory antistatic properties are easy to attain. The nitrogen or sulfur atom content is far preferably from 0.5 mol % to 3.5 mol %, further preferably from 0.5 mol % to 2.5 mol %.

In addition, it is preferable that the nitrogen atom content ratio or the sulfur atom content ratio determined by elementary analysis (ESCA) of the antistatic layer satisfies the following expression (1).

β/α>2.5 Expression (1):

In the expression (1), α and β are nitrogen or sulfur atom contents determined by the elementary analysis of the antistatic layer and, when the total nitrogen or sulfur atom content of the antistatic layer is taken as 100 mol %, α represents a nitrogen or sulfur atom content in the surface-side region of the antistatic layer and β represents a nitrogen or sulfur atom content in the cellulose acylate film-side region of the antistatic layer.

Cases of β/α>2.5 are favorable because satisfactory antistatic properties and chemical resistance are obtained. And cases of 6.6>β/α>2.5 are more favorable.

In the elementary analysis by ESCA, the antistatic layer is etched by a given depth from the surface at a predetermined etching speed and subjected to the elementary analysis. By repeating these operations, compositional variations in the depth direction from the surface toward the inner side are determined. Although the etching method for detection of compositional variations has no particular restrictions, measurement by etching with a C60 ion gun is favorable when an organic material layer is measured for compositional variations in the depth direction, because it can reduce damage to the sample etched.

An antistatic layer according to the invention can be formed by coating on a cellulose acylate film a coating composition in which a conductive compound having hydrophilic properties for use in the invention and a solvent are incorporated, and then by drying the coating composition.

Alternatively, an antistatic layer according to the invention may be formed by further incorporating a multifunctional monomer having two or more polymerizable groups and a photopolymerization initiator into the coating composition and by curing the multifunctional monomer after coating the resulting coating composition. The antistatic layer formed in this way can obtain enhanced hardness and improvements in film strength and scratch resistance.

Ingredients which can be used in addition to conductive compounds in the antistatic layer or a coating composition for forming the antistatic layer are explained below.

(Multifunctional Monomer having Two or More Polymerizable Groups)

In the invention, it is preferable that a multifunctional monomer having two or more polymerizable unsaturated groups is incorporated in a coating composition. The multifunctional monomer having two or more unsaturated groups can function as a curing agent, and the combined use of such a monomer and an antistatic agent allows both retention of conductivity and enhancement of strength and scratch resistance of the coating. The number of polymerizable unsaturated groups is two or more, preferably three or more.

The multifunctional monomers usable in the invention, each having two or more polymerizable unsaturated groups, are illustrated below. These monomers are preferably compounds having polymerizable functional groups, such as (meth)acryloyl groups, vinyl groups, styryl groups or acrylic groups, notably (meth)acryloyl groups or —C(O)OCH═CH₂ groups. Of these compounds, compounds having 3 or more (meth)acryloyl groups per molecule as recited below are preferred over the others.

Examples of a compound having polymerizable unsaturated bonds include (meth)acrylic acid diesters of alkylene glycols, (meth)acrylic acid diesters of polyoxyalkylene glycols, (meth)acrylic acid diesters of polyhydric alcohol, (meth)acrylic acid diesters of ethylene oxide or propylene oxide adducts, epoxy(meth)acrylates, urethane (meth)acrylates and polyester (meth)acrylates.

Of these compounds, (meth)acrylic acid esters of polyhydric alcohols are preferred over the others. Examples of such esters include 1,4-butanediol di(meth)acrylate, 1,6-hexanediol di(meth)acrylate, neopentyl glycol (meth)acrylate, ethylene glycol di(meth)acrylate, triethylene glycol di(meth)acrylate, pentaerythritol tetra(meth)acrylate, pentaerythritol tri(meth)acrylate, trimethylolpropane tri(meth)acrylate, EO-modified trimethylolpropane tri(meth)acrylate, PO-modified trimethylolpropane tri(meth)acrylate, EO-modified phosphoric acid tri(meth)acrylate, trimethylolethane tri(meth)acrylate, ditrimethylolpropanhe tetra(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetrahydroxycyclohexane tetramethacrylate, polyurethane polyacrylate, polyester polyacrylate, and caprolactone-modified tris(acryloxyethyl) isocyanurate.

As multifunctional acrylate compounds having (meth)acryloyl groups, commercial products can also be used. For example, KAYARAD DPHA and KAYARAD PET-30 produced by NIPPON KAYAKU Co., Ltd. can be used.

Descriptions of fluorine-free multifunctional monomers can be found in JP-A 2009-98658, paragraph Nos. (0114) to (0122), and they can apply in the invention too.

### (Photopolymerization Initiator)

In order to form an antistatic layer according to the invention, it is appropriate that a photopolymerization initiator be incorporated in the coating composition to be used. Examples of a photopolymerization initiator usable therein include acetophenones, benzoins, benzophenones, phosphine oxides, ketals, anthraquinones, thioxanthones, azo compounds, peroxides, 2,3-dialkyldione compounds, disulfide compounds, fluoroamine compounds, aromatic sulfoniums, lophine dimmers, onium salts, borate salts, active esters, active halogens, inorganic complexes, and coumarins. Examples, preferred forms and commercial products of photopolymerization initiators are described in JP-A 2009-098658, paragraph Nos. [0133] to [0151], and they can be applied appropriately to the invention also.

In addition, examples of various photopolymerization initiators are described in Saishin UV Koka Gijutsu, p. 159, K K. Gijutsu Joho Kyokai (1991), and Kato Kiyomi, Shigaisen Koka Shisutemu, pp. 65-148, Sogo Gijutsu Senta (1989), and they are useful for the invention.

### (Solvent)

In the invention, incorporation of a carbonate solvent represented by the following formula (IV) or (V) into a coating composition for the antistatic layer is preferable from the viewpoint of localizing a conductive compound to the substrate-side region and ensuring satisfactory antistatic properties and chemical resistance.

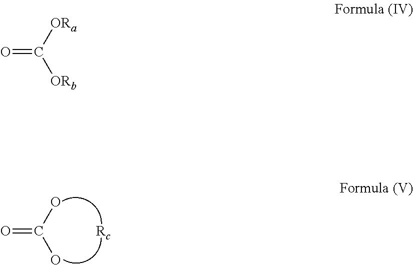

In the formulae, each of Ra and Rb independently represents an alkyl group, and Rc represents an alkylene group.

The formulae (IV) and (V) are illustrated below.

In the formulae, it is preferable that each of Ra and Rb independently represents an alkyl group having a carbon number of 1 to 3 and Rc represents an alkylene group having a carbon number of 1 or 2.

Examples of the alkyl group having a carbon number of 1 to 3 include a methyl group, an ethyl group, an n-propyl group and an isopropyl group. Examples of a solvent of the formula (IV) include dimethyl carbonate, diethyl carbonate, di-n-propyl carbonate and diisopropyl carbonate. And examples of an asymmetric carbonate solvent include methyl ethyl carbonate, methyl n-propyl carbonate and ethyl n-propyl carbonate.

Examples of an alkylene group having a carbon number of 2 or 3 include an ethylene group and an isopropylene group. And examples of a solvent of the formula (V) include ethylene carbonate and propylene carbonate.

The carbonate solvents represented by the formula (IV) or (V) are solvents capable of swelling and dissolving cellulose acylate films in a short time, and they can improve not only adhesiveness of the antistatic layer to a cellulose acylate film but also a leveling property at the time of coating on a TAC (cellulose triacetate) film by use of e.g. a wire-bar coating method or a die coating method. The TAC film formed by a single-layer casting method in particular has a tendency to trail the film formed by a multiple-layer casting method in surface smoothness and, though coating's streaky unevenness attributable to poor flatness of the TAC film tends to develop when an antiglare layer is formed by a wet coating method, the use of a solvent having a boiling temperature of 80° C. or higher, preferably 85° C. or higher, tends to improve the coating's streaky unevenness attributable to poor flatness, and is superior in coating suitability.

The boiling temperature of a carbonate solvent represented by the formula (IV) or (V) is preferably 85° C. or higher, far preferably in a range of 90° C. to 140° C., from the viewpoint of enhancing chemical resistance.

Of the carbonate solvents represented by the formulae (IV) and (V), dimethyl carbonate and diethyl carbonate, especially dimethyl carbonate, are preferred over the others.

Considering suitability for drying at the time of coating and further improvement in leveling property, an organic solvent other than the carbonate solvent of the formula (IV) or (V) can also be incorporated in a coating composition to such an extent as not to impair the composition's adhesiveness, leveling ability at the time of coating and chemical resistance. Examples of such an organic solvent include dibutyl ether, dimethoxyethane, diethoxyethane, propylene oxide, 1,4-dioxane, 1,3-dioxolane, 1,3,5-trioxane, tetrahydrofuran, anisole, phenetole, acetone, methyl ethyl ketone, diethyl ketone, dipropyl ketone, diisobutyl ketone, cyclopentanone, cyclohexanone, methylcyclohexanone, ethyl formate, propyl formate, pentyl formate, methyl acetate, ethyl acetate, propyl acetate, methyl propionate, ethyl propionate, γ-butyrolactone, methyl 2-methoxyacetate, methyl 2-ethoxyacetate, ethyl 2-ethoxyacetate, ethyl 2-ethoxypropionate, 2-methoxyethanol, 2-propoxyethanol, 2-butoxyethanol, 1,2-diacetoxyacetone, acetyl acetone, diacetone alcohol, methyl acetoacetate, ethyl acetoacetate, methyl alcohol, ethyl alcohol, isopropyl alcohol, n-butyl alcohol, cyclohexyl alcohol, isobutyl acetate, methyl isobutyl ketone, 2-octanone, 2-heptanone, 2-hexanone, ethylene glycol ethyl ether, ethylene glycol isopropyl ether, ethylene glycol butyl ether, propylene glycol methyl ether, ethyl carbitol, butyl carbitol, hexane, heptanes, octane, cyclohexane, methylcyclohexane, ethylcyclohexane, benzene, toluene and xylene. These organic solvents may be used alone or as combinations of two or more thereof.

### (Surfactant)

It also suits well to incorporate various types of surfactants into an antistatic layer according to the invention or a coating composition for forming an antistatic layer according to the invention. Surfactants can generally inhibit occurrence of film-thickness unevenness caused by drying-degree variations traceable to a localized distribution of drying-air currents, and besides, they can yield improvements in surface roughness of the antistatic layer and crawling of coatings. Further, the incorporation of surfactants is preferred because there may be cases where surfactants can enhance dispersion of antistatic compounds and develop high conductivity with higher stability.

To be more specific, the surfactants are preferably fluorine-containing surfactants and silicone-type surfactants. In addition, oligomeric or polymeric surfactants are preferable to low-molecular ones.

Upon addition of a surfactant, the surfactant moves immediately to the surface of liquid film coated, and is localized thereto. Even after the film is dried, the surfactant is as-is localized on the film surface. Therefore the surface energy of the surfactant-added antistatic layer is lowered by the surfactant. From the viewpoint of prevention of nonuniform film thickness, crawling and unevenness of the antistatic layer, it is advantageous for the film coated to have low surface energy.

The surface energy (γs^{v}, unit: mJ/m²) of a layer can be experimentally determined by using pure water H₂O and methylene iodide CH₂I₂ on the layer by reference to D. K. Owens, J. Appl. Polym. Sci., vol. 13, p. 1741 (1969). Herein, contact angles of pure water and methylene chloride are denoted as θ_{H2O} and θ_{CH2I2}, γs^{d} and γs^{h} are determined from the following simultaneous equations (1) and (2), and the value γs^{v} represented as the sum of γs^{d} and γs^{h} (γs^{v}=γs^{d}+γs^{h}) is defined as the surface energy equivalent to the surface tension of the constituent layer (conversion from mN/m unit into mJ/m² unit). Prior to measurements, samples are required to undergo humidity conditioning under a specified temperature-and-humidity condition for a given period of time or more. Therein, it is appropriate that the temperature be adjusted to a range of 20° C. to 27° C., the humidity to a range of 50% RH to 65% RH and the humidity conditioning time to 2 hours or more.

1+cos θ_{H2O}=2√γs^{d}(√γ_{H2O}^{d}/γ_{H2O}^{v})+2√γs^{h}(√γ_{H2O}^{h}/γ_{H2O}^{v}) (1)

1+cos θ_{CH2I2}=2√γs^{d}(√γ_{CH2I2}^{d}/γ_{CH2I2}^{v})+2√γs^{h}(√γ_{CH2I2}^{h}/γ_{CH2I2}^{v}) (2)

Herein, γ_{H2O}^{d}=21.8°, γ_{H2O}^{h}=51.0°, γ_{H2O}^{v}=72.8°, γ_{CH2I2}^{d}=49.5°, γ_{CH2I2}^{h}=1.3°, and γ_{CH2I2}^{v}=50.8°.

The suitable surface energy of the antistatic layer is 45 mJ/m² or below, preferably from 20 mJ/m² to 45 mJ/m², further preferably from 20 mJ/m² to 40 mJ/m². By the surface energy adjustment to 45 mJ/m² or below, effects of rendering the thickness of a coating on the antistatic layer uniform and improving crawling can be produced. However, when an upper layer such as a low refractive-index layer is further coated on a surfactant-added layer, the surfactant added is preferably a surfactant capable of being eluted from the layer and moving to the upper layer, and the surface energy of the surfactant-added layer after the layer is immersed in a solvent (for example, methyl ethyl ketone, methyl isobutyl ketone, toluene, or cyclohexanone) used for the upper-layer coating composition and the solvent is flushed away is preferably high rather than low, and more specifically, it is appropriate that the surface energy be from 35 mJ/m² to 70 mJ/m².

Preferred forms and examples of fluorine-containing surfactants are described in JP-A 2007-102206, paragraph Nos. (0023) to (0080), and they can apply in the invention too.

Suitable examples of silicone compounds include compounds each containing a plurality of dimethylsilyloxy units as repeating structural units and having substituents at the compound chain ends and/or side chains. In the compound chain containing dimethylsilyloxy units as repeating structural units, structural units other than dimethylsilyloxy units may be included. The substituents may be the same or different from one another, and the number thereof is preferably two or more. Examples of a suitable substituent include a polyether group, an alkyl group, an aryl group, an aryloxy group, an acryloyl group, a methacryloyl group, a vinyl group, a cinnamoyl group, an epoxy group, an oxetanyl group, a hydroxyl group, a fluoroalkyl group, a polyoxyalkylene group, a carboxyl group, and a group containing an amino group or the like.

The molecular weight of those silicone compounds, though not particularly limited, is preferably a hundred thousand or below, far preferably 50,000 or below, further preferably from 1,000 to 30,000, especially preferably from 1,000 to 20,000.

The silicon atom content of such a silicon compound has no particular limits, but it is preferably 18.0 mass % or above, far preferably from 25.0 mass % to 37.8 mass %, especially preferably from 30.0 mass % to 37.0 mass %.

Examples of suitable silicon compounds include, but not limited to, products of Shin-Etsu Chemical Co., Ltd., X-22-174DX, X-22-2426, X-22-164B, X22-164C, X-22-170DX, X-22-176D and X-22-1821 (all of which are trade names); products of CHISSO CORPORATION, FM-0725, FM-7725, FM-4421, FM-5521, FM-6621 and FM-1121 (all of which are trade names); products of Gelest Inc., DMS-U22, RMS-033, RMS-083, UMS-182, DMS-H21, DMS-H31, HMS-301, FMS121, FMS123, FMS131, FMS141 and FMS221 (all of which are trade names); products of Dow Corning Toray Co., Ltd., SH200, DC11PA, SH28PA, ST80PA, ST86PA, ST97PA, SH550, SH710, L7604, FZ-2105, FZ2123, FZ2162, FZ2191, FZ2203, FZ-2207, FZ-3704, FZ-3736, FZ-3501, FZ-3789, L-77, L-720, L-7001, L-7002, L-7604, Y-7006, SS-2801, SS-2802, SS-2803, SS-2804 and SS-2805 (all of which are trade names); and products of Momentive Performance Materials Japan Inc., TSF400, TSF401, TSF410, TSF433, TSF4450 and TFS4460 (all of which are trade names).

It is appropriate that the amount of these surfactants incorporated be from 0.01 mass % to 0.5 mass %, preferably 0.01 mass % to 0.3 mass %, of the total solids in a coating composition for forming the antistatic layer.

### (Translucent Particles)

In the antistatic layer according to the invention, various kinds of translucent particles can be used for the purpose of imparting an antiglare property (a surface scattering property) and an internal scattering property.

The translucent particles may be either organic ones or inorganic ones. When the variations in particle size are small, the variability of scattering characteristics becomes the less, and the haze-value design becomes the easier. As the translucent particles, plastic beads are suitable, and it is particularly preferable that the beads have high transparency and such a difference in refractive index as mentioned below when compared with binder used together.

Examples of organic particles include polymethyl methacrylate particles (refractive index: 1.49), cross-linked acrylic-styrene copolymer particles (refractive index: 1.54), melamine resin particles (refractive index: 1.57), polycarbonate particles (refractive index: 1.57), polystyrene particles (refractive index: 1.60), cross-linked polystyrene particles (refractive index: 1.61), polyvinyl chloride particles (refractive index: 1.60) and benzoguanamine-melamine formaldehyde particles (refractive index: 1.68).

Examples of inorganic particles include silica particles (refractive index: 1.44), alumina particles (refractive index: 1.63), zirconia particles, titania particles and inorganic particles having hollows or pores.

Of those particles, cross-linked polystyrene particles, cross-linked poly((meth)acrylate) particles and cross-linked poly(acrylic-styrene) particles are preferred over the others. The refractive index of a binder to be used is adjusted to match with the refractive index of translucent particles selected from those particles, and thereby the internal haze, surface haze and center-line average roughness specified by the invention can be attained.

Further, a combined use of a binder derived mainly from a trifunctional or higher (meth)acrylate (refractive index after curing: 1.50-1.53) and translucent particles of a cross-linked (meth)acrylate polymer having an acrylic content of 50 mass % to 100 mass %, notably translucent particles of a cross-linked styrene-acrylic copolymer (refractive index: 1.48-1.54), is advantageous.

The refractive index of an ingredient usable as binder in the invention (mixture of ingredients other than those making up translucent particles) and the refractive index of translucent particles are preferably from 1.45 to 1.70, far preferably from 1.48 to 1.65.

A difference in refractive index between a binder usable in the invention and translucent particles (a value obtained by subtracting a refractive index of binder from a refractive index of translucent particles), as expressed in absolute value, is preferably from 0.001 to 0.030, far preferably from 0.001 to 0.020, further preferably from 0.001 to 0.015. When this difference is greater than 0.030, there occur problems, such as blurring of characters on film, a drop in darkroom contrast and appearance of white turbidity on the surface. For adjusting the difference in refractive index to fall within the range specified above, appropriate choices of the kinds and amounts of binder and translucent particles and the mixing ratio between them are good enough. What choices should be done can be known empirically in advance, and that with ease.

Herein, the refractive index of binder can be determined and evaluated by direct measurement with an Abbe refractometer or by spectral reflection spectrum or spectral ellipsometry measurement. The refractive index of translucent particles is determined by dispersing the translucent particles into an equivalent amount of any of solvents having refractive indexes made to differ from one another by mixing two kinds of solvents having different refractive indexes at various ratios, subjecting each dispersion obtained to turbidity measurement, and measuring a refractive index of the solvent showing the minimum turbidity with an Abbe refractometer.

In the case of such translucent particles, because the translucent particles tend to cause sedimentation in the binder, an inorganic filler like silica may be added for the purpose of preventing the sedimentation. Although the addition of an inorganic filler in greater amount is the more effective for the prevention of sedimentation of translucent particles, it produces ill effect on the transparency of a coating film. It is therefore appropriate that an inorganic filler 0.5 μm or below in particle size be added to an extent of not impairing the transparency of a coating film, or in an amount smaller than 0.1 mass % with respect to a binder.

The average size (on a volume basis) of translucent particles is preferably from 0.5 μm to 20 μm, far preferably from 2.0 μm to 15.0 μm. The average particle sizes smaller than 0.5 μm are undesirable because the distribution of light scattering angles is broaden into wide angles and blurring of characters on a display is caused. On the other hand, the average particle sizes greater than 20 μm require increasing the thickness of a layer to which the particles are added and cause problems of curling, an increase in cost and so on.

Additionally, two or more kinds of translucent particles different in particle size may be used in combination. In this case, the use of translucent particles greater in particle size can impart antiglare properties, while the use of translucent particles smaller in particle size can reduce a gritty feel of the coating surface.

It is appropriate that the translucent particles be incorporated in a proportion of 3 mass % to 30 mass %, preferably 5 mass % to 20 mass %, with respect to the total solids in the antistatic layer. The content of 3 mass % or above can produce sufficient addition effect, while the content of 30 mass % or below can prevent problems such as blurring of images, occurrence of white turbidity and glare in the surface, and so on.

In addition, the density of translucent particles is preferably from 10 mg/m² to 1,000 mg/m², far preferably from 100 mg/m² to 700 mg/m².

Into an antistatic layer according to the invention, other additives can further be incorporated too. Examples of such additives include compounds capable of inhibiting decomposition of polymers, such as ultraviolet absorbents, phosphorous acid esters, hydroxamic acid, hydroxyamines, imidazole, hydroquinone and phthalic acid. Further, inorganic fine particles, polymer fine particles or a silane coupling agent can be added to the antistatic layer for the purpose of heightening the layer strength, and fluorine-containing compounds (notably a fluorine-containing surfactant) can also be added for reduction in refractive index and enhancement of transparency.

### (Composition for Forming Antistatic Layer)

A composition used for forming an antistatic layer in accordance with the invention preferably contain a conductive compound, a multifunctional monomer having two or more polymerizable groups, a photopolymerization initiator and a carbonate solvent.

Contents of various ingredients in a coating composition used for forming the antistatic layer are described below. Additionally, the term “content” as used herein refers to the percentage (by mass) of a solid component in each ingredient on the total solids in the coating composition. The conductive compound content is preferably from 0.1 mass % to 40 mass %, far preferably from 0.5 mass % to 30 mass %, especially preferably from 1 mass % to 20 mass %. The content of multifunctional monomer having two or more polymerizable groups is preferably from 50 mass % to 99 mass %, far preferably from 75 mass % to 99 mass %, especially preferably from 80 mass % to 97 mass %. The content of photopolymerization initiator is preferably from 1 mass % to 10 mass %, far preferably from 1 mass % to 5 mass %.

When the conductive compound content is in the range specified above, sufficient antistatic effects and chemical resistance can be achieved and no decline in layer strength occurs. When the multifunctional monomer having two or more polymerizable groups is present in a content of 50 mass % or above, a sufficient strength of layer can be attained. When the photopolymerization initiator is present in a content of 1 mass % or above, curing reaction is promoted and a sufficient layer strength can be attained.

It is appropriate that the solvent be used in an amount allowing the concentration of solids in the coating composition to fall within a range of 1 mass % to 70 mass %, preferably a range of 20 mass % to 70 mass %, especially preferably a range of 30 mass % to 65 mass %.

The total solvent content of coating composition is a value obtained by subtracting the concentration of solids from the coating composition's total mass taken as 100 mass %, and the total solvent content is preferably from 30 mass % to 99 mass %, far preferably from 30 mass % to 80 mass %, especially preferably from 35 mass % to 70 mass %. Herein, the term “total solvent content” refers to the percentage of the amount of total solvents (% by mass) on the total mass of the coating composition.

The total solvent content lower than 30 mass % is undesirable because such a content makes it difficult to achieve the present effects and causes an increase in composition's viscosity and leads to deterioration in leveling property and surface condition. On the other hand, the total solvent content higher than 80 mass % is also undesirable because it is contributable to achievement of present effects, but causes an increase in amount to be coated for attaining an intended layer thickness and a productivity reduction resulting from protraction of drying.

It is appropriate that the content of carbonate solvent represented by the formula (IV) or the formula (V) constitute 5 mass % to 80 mass %, preferably 10 mass % to 70 mass %, especially preferably 15 mass % to 60 mass %, of the total solvent content of coating composition for use in the invention.

### (Physical Properties of Antistatic Layer)

It is appropriate that the antistatic layer according to the invention range in refractive index from 1.48 to 1.65, preferably from 1.48 to 1.60, especially preferably from 1.48 to 1.55. The refractive index adjusted to fall within such a range is favorable because it allows suppressing unevenness resulting from interference of the antistatic layer with the substrate, and besides, it can render a tint of reflected light neutral in the case of stacking a low refractive-index layer on the antistatic layer.

The thickness of the antistatic layer is 1 μm or above, preferably from 6 μm to 20 μm, far preferably from 6 μm to 18 μm, especially preferably from 6 μm to 15 μm. By adjusting the thickness to fall within such a range, compatibility between physical strength and conductivity can be achieved.

The transmittance of the antistatic layer is preferably 80% or above, far preferably 85% or above, especially preferably 90% or above.

### <Optical Film>

The hardness of the present optical film is preferably H or higher, far preferably 2H or higher, especially preferably 3H or higher, as determined by pencil hardness testing under a load of 500 g.

It is advantageous for the present optical film to have a total haze value of 0.1% or greater and smaller than 1%, what's more to have an arithmetic mean roughness Ra of 0.03 μm or below, as measured on the basis of JIS B0601. The values in these ranges are favorable because they can contribute to attainment of excellent translucency and smoothness and satisfactory viewability.

And it is far preferred that the total haze value be from 0.1% or greater and smaller than 0.5% and the Ra value be from 0.001 μm to 0.015 μm.

When the surface resistivity SR (Ω/sq) of the present optical film is expressed in its common logarithm log SR, the smaller log SR is the better from the viewpoint of antistatic properties. More specifically, in 25° C.-60% RH surroundings, the log SR is preferably 12 or below, far preferably from 5 to 11, further preferably from 6 to 10. By adjusting the surface resistivity to fall within such a range, it becomes possible to impart excellent dustproof properties.

In order to attain such surface resistivity, depending on the type of a conductive compound used, the conductive compound content of the antistatic layer is adjusted preferably to fall within a range of 0.1 g/m² to 3.5 g/m², far preferably to fall within a range of 0.5 g/m² to 2.5 g/m₂, in the case of using an ion-conducting compound, while in the case of using an electron-conducting compound its content is adjusted preferably to fall within a range of 0.01 g/m² to 1.0 g/m², far preferably to fall within a range of 0.05 g/m² to 0.5 g/m².

### (Method for Making Optical Film)

The present optical film can be formed in accordance with the following methods, but the methods for forming it should not be construed as being limited to the following.

First, a coating composition for forming the antistatic layer is prepared. Then, the coating composition is coated on a transparent substrate by use of a dip coating method, an air-knife coating method, a curtain coating method, a roller coating method, a wire-bar coating method, a gravure coating method, a die coating method or so on, and further heated and dried. Herein, the use of a microgravure coating method, a wire-bar coating method or a die coating method (see U.S. Pat. No. 2,681,294 and JP-A 2006-122889), especially a die coating method, is preferred.

After the coating, the layer formed from the coating composition for forming the antistatic layer is dried, and cured by irradiation with light. Thus the antistatic layer is formed. Alternatively, it is also possible to form the antistatic layer by coating in advance other layers as required (layers to make up the optical film, including a hard coating layer and an antiglare layer, which are mentioned below) on a transparent substrate, and thereon forming the antistatic layer. In this manner, the present optical film is obtained.

### (Hard Coating Layer)

On the present optical film, a hard coating layer can also be provided for the purpose of enhancing physical strength of the film. Although it is advantageous for the present antistatic layer to serve as a hard coating layer too, it is also possible to provide a hard coating layer for the purpose of imparting higher hard coating properties.

In point of an optical design for obtaining antireflection properties, the refractive index of the hard coating layer is preferably from 1.48 to 1.65, far preferably from 1.48 to 1.60, especially preferably from 1.48 to 1.55.

From the viewpoint of imparting sufficient durability and impact resistance to the film, the thickness of the hard coating layer is preferably from 0.5 μm to 20 μm, far preferably from 1 μm to 10 μm, further preferably from 1 μm to 5 μm.

The hardness of the hard coating layer is preferably H or higher, far preferably 2H or higher, especially preferably 3H or higher, as determined by the pencil hardness testing. Further, when Taber tests are performed in compliance with JIS K5400, the smaller the amount of a specimen abraded by the test, the more favorable the hardness of the specimen.

As the binder component of the hard coating layer, the monomers given as examples of a multifunctional monomer having two or more polymerizable unsaturated groups can be suitably used.

Into the hard coating layer, matte particles having an average size of 1.0 μm to 10.0 μm, preferably 1.5 μm to 7.0 μm, such as particles of an inorganic compound or a resin, may be incorporated for the purpose of imparting an internal scattering property.

To the binder of the hard coating layer, monomers or inorganic particles with various refractive indexes, or both can be added for the purpose of controlling the refractive index of the hard coating layer. In addition to the effect of controlling the refractive index, the inorganic particles have an effect of inhibiting curing shrinkage by cross-linking reaction. In the invention, polymers produced by polymerization of multifunctional monomers and/or high refractive-index monomers after forming a hard coating layer, inclusive of inorganic particles dispersed therein, are referred to as binders. The use of silica fine particles as the inorganic fine particles for controlling the refractive index is preferred from the viewpoint of inhibiting tint variations from occurring through interference of the hard coating layer with the substrate.

### (Antiglare Layer)

In addition to the antistatic layer, an antiglare layer may be formed in the invention for the purpose of imparting antiglare properties resulting from surface scattering and hard coating properties, preferably for enhancing film hardness and scratch resistance, to the film.

Descriptions of an antiglare layer can be found in JP-A 2009-98658, paragraph Nos. (0178) to (0189), and they can apply in the invention too.

In the case of providing on a transparent substrate a double-layer structure made up of e.g. a hard coating layer (antiglare layer) and an antistatic layer, a method of simultaneously forming the two coating layers in a single coating process can also be adopted.

By simultaneously forming the two layers, or the hard coating layer and the antistatic layer, in a single coating process, it becomes possible to achieve low cost and high productivity. As the method of simultaneously forming two layers in a single coating process, any of known methods can be used. To be more specific, the methods disclosed e.g. in JP-A 2007-293302, paragraph Nos. (0032) to (0056), can be utilized.

### (High Refractive-Index Layer and Medium Refractive-Index Layer)

The refractive index of a high refractive-index layer is preferably from 1.65 to 2.20, far preferably from 1.70 to 1.80, and the refractive index of a medium refractive-index layer is adjusted to have a value lying somewhere between the refractive index of a low refractive-index layer and that of the high refractive-index layer. The refractive index of the medium refractive-index layer is preferably from 1.55 to 1.65, far preferably from 1.58 to 1.63.

As the methods for forming the high refractive-index layer and the medium refractive-index layer, methods of forming thin films of inorganic oxides by use of chemical vapor deposition (CVD) techniques or physical vapor deposition (PVD) techniques, notably vacuum deposition and sputtering techniques included in physical vapor deposition techniques, can be used. However, the method of adopting an all-wet coating process is advantageous.

The medium refractive-index layer and the high refractive-index layer have no particular restrictions so long as they have their refractive indexes in the ranges specified above, respectively, and known ingredients can be used as their constituents. To be more specific, those disclosed in JP-A 2008-262187, paragraph Nos. (0074) to (0094), are usable.

### (Low Refractive-Index Layer)

The present optical film preferably has a low refractive-index layer on the antistatic layer directly or via other layers. In this case, the present optical film can function as an antireflection film.

Herein, the refractive index of the low refractive-index layer is preferably from 1.30 to 1.51, far preferably from 1.30 to 1.46, further preferably from 1.32 to 1.38. Adjusting the refractive index to fall within such a range is favorable because the reflectivity can be controlled and the film strength can be retained. As the methods for forming the low refractive-index layer, though methods of forming thin films of inorganic oxides by use of chemical vapor deposition (CVD) techniques or physical vapor deposition (PVD) techniques, notably vacuum deposition and sputtering techniques included in physical vapor deposition techniques, can also be used, the method of using a composition for forming a low refractive-index layer and forming the low refractive-index layer in an all-wet coating process is used to advantage.

The low refractive-index layer has no particular restrictions so long as its refractive index is in the range specified above, and known ingredients can be used as its constituents. To be more specific, the composition including a fluorine-containing curable resin and inorganic fine particles as disclosed in JP-A 2007-298974 and the low refractive-index coatings in which hollow silica fine particles are incorporated as disclosed in JP-A 2002-317152, JP-A 2003-202406, and JP-A 2003-292831 can be suitably used.

### <Protective Film for Use in Polarizing Plate>

When the optical film is used as a surface protective film of a polarizer (a protective film for use in a polarizing plate), the transparent substrate surface on the side opposite to the side on which the substrate has a thin film layer, namely the substrate surface to undergo lamination of the polarizer, is subjected to the so-called saponification treatment so as to have hydrophilic properties, and thereby adhesiveness of the substrate surface to the polarizer constituted mainly of polyvinyl alcohol can be improved.

Of two protective films of a polarizer, it is also preferable that the film other than the optical film is an optical compensation film having optical compensation layers including an optically anisotropic layer. The optical compensation film (phase-difference film) can improve viewing angle characteristics of a liquid-crystal display screen.

As the optical compensation film, any of known ones can be used, but the optical compensation film disclosed in JP-A 2001-100042 is preferable from the viewpoint of extending the viewing angle.

An explanation of the saponification treatment is given. The saponification treatment is treatment that an optical film is immersed in a warmed aqueous alkali solution for a given time, washed with water, and further washed with an acid for neutralization. The saponification treatment may be performed under any conditions so long as the surface on the side where the substrate receives lamination of a polarizer comes to have hydrophilic properties. Therefore the concentration of a treatment agent, the temperature of a treatment solution and the treatment time can be chosen as appropriate. From the necessity of securing ordinary productivity, however, the treatment conditions which allow the treatment to finish within 3 minutes are chosen. As to the general conditions, the alkali concentration is in a range of 3 mass % to 25 mass %, the treatment temperature is in a range of 30° C. to 70° C. and the treatment time is in a range of 15 seconds to 5 minutes. The alkali species used suitably for the alkali treatment is sodium hydroxide or potassium hydroxide, the acid used for acid washing is sulfuric acid, and the water used suitably for washing is ion exchange water or pure water.

The antistatic layer of the present optical film can retain its antistatic power in a good condition even when exposed to an aqueous alkali solution by such saponification treatment.

When the present optical film is used as the surface protective film of a polarizer (protective film for use in a polarizing plate), it is preferable that the cellulose acylate film is a cellulose triacetate film.

### <Polarizing Plate>

Then a polarizing plate according to the invention is explained.

The present polarizing plate is a polarizing plate having a polarizer and two protective films for protecting both surfaces of the polarizer, and characterized in that at least one of the protective films is the present optical film or antireflection film.

Examples of the polarizer include iodine-type polarizers, dye-type polarizers using dichromatic dyes, and polyene-type polarizers. The iodine-type polarizers and the dye-type polarizers can generally be made with films of polyvinyl alcohol type.

The polarizer is preferably configured so that the cellulose acylate film of the optical film is bonded to the polarizer, if needed, via an adhesive layer constituted mainly of polyvinyl alcohol and, on the other side of the polarizer, a protective film is provided. And the protective film may have a tackiness agent layer on the side opposite to the side on which the polarizer is placed.

By using the present optical film as a protective film for use in a polarizing plate, the polarizing plate having excellent physical strength, antistatic properties and durability can be made.

In addition, the present polarizing plate can also have an optical compensation function. In this case, it is preferable that, of two surface protective films, only either the surface protective film on the front side or the surface protective film on the rear side is formed with the present optical film and the surface protective film on the side opposite to the side on which the polarizing plate has the optical film is an optical compensation film.

By making the polarizing plate using the present optical film as one of the polarizing-plate protective films and an optical compensation film having optical anisotropy as the other of the polarizing-plate protective films, the contrast and vertical and lateral viewing angles of liquid crystal display apparatus in an illuminated room can be further improved.

### <Image Display Apparatus>

Image display apparatus according to the invention has the present optical film, antireflection film or polarizing plate on the topmost surface of its display.

The present optical film can be used suitably in image display apparatus such as a liquid crystal display (LCD), a plasma display panel (PDP), an electroluminescent display (ELD) or a cathode-ray tube (CRT) display.

The present optical film can be advantageously used in such image display apparatus as a liquid crystal display in particular, and it is particularly advantageous to use the present optical film as the topmost layer on the backlight side of a liquid crystal cell in transmission/semi-transmission liquid crystal display apparatus.

The liquid crystal display apparatus generally has a liquid crystal cell and two polarizing plates disposed on both sides of the liquid crystal cell, and the liquid crystal cell bears a liquid crystal between two electrode substrates. Further, one optically anisotropic layer is disposed between the liquid crystal cell and one of the polarizing plates, or two optically anisotropic layers may be disposed between the liquid crystal cell and both of the polarizing plates, respectively.

The liquid crystal cell is preferably in a TN mode, a VA mode, an OCB mode, an IPS mode or an ECB mode.

### (Various Characteristic Values)

Various measuring methods relating to the invention and evaluation criteria of measurement results are shown below.

### (1) Surface Resistance Measurement

After it is allowed to stand for 2 hours under a 25° C.-60% RH condition, a sample is subjected to measurement by means of a super-insulating resistance/microampere meter TR8601 (made by ADVANTEST CORPORATION), and the surface resistance value obtained is expressed in common logarithm (log SR). The smaller the log SR value, the better the surface resistance of the sample. In the invention, it is appropriate that the log SR value be 10 or below.

### (2) Pencil Hardness Evaluation

The pencil hardness evaluation described in JIS K 5400 is made. After an optical film sample is subjected to 2-hour humidity conditioning under a 25° C.-60% RH condition, pencil hardness testing for the sample is carried out using test pencils defined by JIS S 6006. In the invention, hardness of 3H or above is suitable.

### (3) Adhesiveness Evaluation

Adhesiveness is evaluated by cross-cut peel test described in JIS K 5400. More specifically, the surface of a sample is cut in a grid pattern having 100 squares with dimensions of 1×1 mm, and subjected to cross-cut adhesion test using cellophane tape (made by NICHIBAN CO., LTD.). New cellophane tape is placed on the sample, and then peeled away. When 90% or more of the squares remain without being peeled away, adhesiveness of the sample is rated as good. When 50% or more and less than 90% of the squares remain without being peeled away, adhesiveness of the sample is rated as fair. When the percentage of squares remaining is less than 50%, adhesiveness of the sample is rated as bad.

### (4) Haze Measurement

Haze measurement is made by using a haze meter (NDH2000, made by Nippon Denshoku Industries Co., Ltd.) in 25° C.-60% RH surroundings. The haze value is preferably 0.5 or below, far preferably 0.3 or below.

### (5) Surface Roughness Measurement

The center-line average roughness (Ra) of a sample surface is measured by using a SURFCORDER MODEL SE-3F made by Kosaka Laboratory Ltd. in conformance with JIS B 0601 (1982). The measurement is carried out under conditions that the evaluation length is 2.5 mm, the cutoff is 0.08 mm, the speed is 0.5 mm/sec, the probe diameter is 2 μm and the load is 30 μN.

### (6) Chemical Resistance Testing

Chemical resistance testing is carried out through treatment of a test sample by 1.5-minute immersion in an aqueous sodium hydroxide solution (2.5N) warmed to 40° C., then washing with 20° C. pure water for 30 seconds, further immersion in a 25° C. aqueous sulfuric acid solution (0.1N) for 30 seconds, and furthermore washing with 20° C. pure water for 30 seconds. Being smaller in difference from the log SR before testing, Δ log SR, means the better chemical resistance, and it is appropriate that Δ log SR be 0.3 or smaller.

### (7) Localization Evaluation on Conductive Compound (Determination of α and β Values)

Electron spectroscopy for chemical analysis (ESCA) is performed with ESCA-3400 (made by Shimadzu Corporation) under condition that the exciting X-ray used is MgKα (1253.6 eV), the X-ray diameter is 8 mm, the X-ray output is 12 kV and the photoelectron escape angle is 35°. And various areas of a sample are etched at a depth of 100 nm at a time in the depth direction from the top surface layer by means of C60 ion etching under a 10 kV-10 nA condition, and subjected to elementary analysis. Thereby the nitrogen or sulfur atom content for every 100 nm depth in each area is calculated in a percentage by mole (mol %) on the total content of each atom. As to the α value, nitrogen or sulfur atom contents expressed in mol % are determined in the region extending from the topmost surface to a depth of 0.5 μm in each area of the antistatic layer, and the mean value of these content data in this depth region is calculated and defined as the α value. As to the β value, nitrogen or sulfur atom contents expressed in mol % are determined in the region extending from a depth of 0.5 μm to a depth of 1 μm in each area of the antistatic layer, and the mean value of these content data in this depth region is calculated and defined as the β value.

### EXAMPLES

The invention will now be illustrated in further detail by reference to the following examples, but these examples should not be construed as limiting the scope of the invention. Additionally, all parts and percentages in the following examples are by mass unless otherwise indicated.

### Preparation Example 1

### Preparation of Antistatic Composition H1

In a vessel were placed 6.8 parts by mass of a conductive-compound-in-solvent dispersion A, 38.6 parts by mass of DPHA, 44.6 parts by mass of propylene glycol monomethyl ether, 8.7 parts by mass of dimethyl carbonate and 1.3 parts by mass of a photopolymerization initiator IRGACURE 127 (trade name, a product of Ciba Japan K.K.). These ingredients were mixed with stirring, and then filtered through a polypropylene filter having a pore size of 1.0 μm. Thus, an antistatic composition was prepared.

Similarly to the above, various ingredients were mixed as shown in Table 1, and coating solutions H1 to H11 for forming antistatic layers were prepared.

TABLE 1

| | Dispersion of | | | | | | | |
|---|---|---|---|---|---|---|---|---|
| | Conductive | | Multifunctional | | | | | |
| | Compound | | Monomer | | Initiator | | | |
| Coating | | Amount | | Amount | | Amount | Solvent for Dilution | |
| Solution | Variety | (mass %) | Species | (mass %) | Species | (mass %) | (mass %) | note |
| H1 | Dispersion A | 5 | DPHA | 92 | Irg.127 | 3 | PGM(79)/IPA(6)/DMC(15) | Invention |
| H2 | Dispersion A | 10 | DPHA | 87 | Irg.127 | 3 | PGM(72)/IPA(13)/DMC(15) | Invention |
| H3 | Dispersion A | 10 | DPHA | 87 | Irg.127 | 3 | PGM(66)/IPA(9)/DMC(25) | Invention |
| H4 | Dispersion A | 10 | DPHA | 87 | Irg.127 | 3 | PGM(51)/IPA(9)/DMC(40) | Invention |
| H5 | Dispersion A | 10 | DPHA | 87 | Irg.127 | 3 | PGM(66)/IPA(9)/DEC(25) | Invention |
| H6 | Dispersion A | 10 | DPHA | 87 | Irg.127 | 3 | PGM(66)/IPA(9)/methyl | Comparative |
| | | | | | | | acetate(25) | Example |
| H7 | Dispersion A | 10 | DPHA | 87 | Irg.127 | 3 | PGM(91)/IPA(9) | Comparative |
| | | | | | | | | Example |
| H8 | Dispersion B | 10 | DPHA | 87 | Irg.127 | 3 | PGM(66)/IPA(9)/DMC(25) | Invention |
| H9 | Dispersion B | 10 | DPHA | 87 | Irg.127 | 3 | PGM(66)/IPA(9)/DEC(25) | Invention |
| H10 | Dispersion B | 10 | DPHA | 87 | Irg.127 | 3 | PGM(76)/IPA(9)/methyl acetate | Comparative |
| | | | | | | | (15) | Example |
| H11 | Dispersion B | 10 | DPHA | 87 | Irg.127 | 3 | PGM(91)/IPA(9) | Comparative |
| | | | | | | | | Example |

The ingredients used and abbreviations of their full names are explained below.

Dispersion A: Disperse system containing IP-9 as a solid component in a concentration of 30.7% in a dispersion solvent, wherein the dispersion solvent is a 30:70 by mass mixture of propylene glycol monomethyl ether and isopropyl alcohol.

Dispersion B: Disperse system containing IP-13 as a solid component in a concentration of 30.7% in a dispersion solvent, wherein the dispersion solvent is a 30:70 by mass mixture of propylene glycol monomethyl ether and isopropyl alcohol.

DPHA: Mixture of dipentaerythritol pentaacrylate and dipentaerythritol hexaacrylate, KAYARAD DPHA (trade name, a product of NIPPON KAYAKU Co., Ltd.)

Irg. 127: IRGACURE 127 (trade name, a product of Ciba Japan K.K.)

PGM: Propylene glycol monomethyl ether (produced by Wako Pure Chemical Industries, Ltd.)

IPA: Isopropyl alcohol (produced by Wako Pure Chemical Industries, Ltd.)

DMC: Dimethyl carbonate (produced by Tokyo Chemical Industry Co., Ltd.)

DEC: Diethyl carbonate (produced by Wako Pure Chemical Industries, Ltd.)

### (Preparation of Dispersion Liquid (F) Containing Hollow Silica Particles)

To 500 parts of hollow silica particulate sol (isopropyl alcohol silica sol CS60-IPA, produced by Shokubai Kasei Kogyo K.K., average particle size: 60 nm, shell thickness: 10 nm, silica concentration: 20%, refractive index of silica particles: 1.31), 20 parts of acryloyloxypropyltrimethoxysilane and 1.5 parts of diisopropoxyaluminum ethylacetate were added. And these ingredients were mixed together, and thereto 9 parts of ion exchange water was added. The resulting mixture was subjected to 8-hour reaction at 60° C., and then cooled to room temperature. Thereto, 1.8 parts of acetyl acetone was added, and a dispersion solution (E) was thus prepared. Thereafter, a dispersion (F) having a solids concentration of 18.2% was prepared by making solvent replacement and final concentration adjustment, wherein the solvent replacement was made by performing distillation of the dispersion solution (E) under a reduced pressure of 30 Torr while adding cyclohexanone so as to keep the silica content nearly constant. The remaining IPA content of the thus obtained dispersion was found to be 0.5% or below by gas chromatographic analysis.

### (Preparation of Coating Solution for Forming Low Refractive-Index Layer)

For the purpose of forming a low refractive-index layer, various ingredients were mixed together as shown in Table 2, and dissolved in methyl ethyl ketone. Thus a coating solution Ln 1 having a solid content of 5% was prepared.

TABLE 2

| | Content (solid content) | | | | | | | |
|---|---|---|---|---|---|---|---|---|
| | | | | | Polymerization | | | Hollow Silica |
| | Binder | | | | Initiator | | | Dispersion Liquid |
| | | Amount | | Amount | | Amount | RMS-033 | (F) |
| | Species | (mass %) | Species | (mass %) | Species | (mass %) | (mass %) | (mass %) |
| Ln1 | P-1 | 28 | DPHA | 10 | Irg.127 | 3 | 4 | 55 |

Additionally, the abbreviations in Table 2 are as follows.

P-1: Fluorine-containing copolymer P-3 (mass-average molecular weight: about 50,000) disclosed in JP-A 2004-45462)

RMS-033: Methacryloxy-modified silicone (produced by Gelest Inc.)

### (Making of Antistatic Layer)

On an 80 μm-thick cellulose triacetate film (TD80UF, produced by FUJIFILM Corporation, refractive index: 1.48) as a transparent substrate, each of the coating solutions for forming antistatic layers was coated by means of a gravure coater. The layer coated was dried at 60° C. for about 2 minutes, and then cured by irradiation with ultraviolet rays from a 160 W/cm air-cooled metal halide lamp (made by Eyegraphics Co., Ltd.) at an illuminance of 400 mW/cm² in an exposure dose of 120 mJ/cm² under the atmosphere purged with nitrogen so as to have an oxygen concentration of 1.0 vol % or below, thereby forming each antistatic layer having a thickness of 8 μm. Thus, antistatic layer-equipped optical films (Samples HC1 to HC11) were made.

(Making of Samples having Received Chemical Resistance Testing)

Half of each of the samples on various levels (Sample Nos. HC1 to HC11) was subjected to the chemical resistance testing. Thus, the intended samples were made.

### (Evaluation of Optical Film)

Various properties of each of the optical films were evaluated according to the methods mentioned above. Results obtained are shown in Table 3.

TABLE 3

| | | | | | | | | | | Properties |
|---|---|---|---|---|---|---|---|---|---|---|
| | | | | | | | | | | after |
| | | | | | | | | | | Chemical |
| | | Properties of Coating Solution Sample | | | | | | | | Resistance |
| | Sample | | Pencil | | | | | | | Testing |
| | No. | Conductivity | Hardness | Adhesiveness | Haze | Ra | α | β | α/β | ΔlogSR |
| Example 1 | HC1 | 9.4 | 3H | good | 0.2 | 0.007 | 2.3 | 6.3 | 2.7 | 0.2 |
| Example 2 | HC2 | 9.3 | 3H | good | 0.3 | 0.006 | 2.2 | 6.4 | 2.9 | 0.2 |
| Example 3 | HC3 | 9.2 | 3H | good | 0.2 | 0.006 | 2.2 | 7.3 | 3.3 | 0.0 |
| Example 4 | HC4 | 9.2 | 3H | good | 0.2 | 0.006 | 2.1 | 7.3 | 3.5 | 0.0 |
| Example 5 | HC5 | 9.2 | 3H | good | 0.3 | 0.006 | 2.2 | 7.0 | 3.1 | 0.1 |
| Comparative | HC6 | 9.2 | 3H | good | 0.4 | 0.015 | 8.1 | 2.2 | 0.3 | 3.1 |
| Example 1 | | | | | | | | | | |
| Comparative | HC7 | 9.2 | 3H | bad | 0.2 | 0.006 | 12.8 | 2.0 | 0.2 | 6.6 |
| Example 2 | | | | | | | | | | |
| Example 6 | HC8 | 9.6 | 3H | good | 0.2 | 0.007 | 2.1 | 6.9 | 3.3 | 0.0 |
| Example 7 | HC9 | 9.6 | 3H | good | 0.2 | 0.006 | 2.2 | 6.8 | 3.1 | 0.0 |
| Comparative | HC10 | 9.5 | 3H | good | 0.4 | 0.014 | 8.1 | 2.2 | 0.3 | 3.2 |
| Example 3 | | | | | | | | | | |
| Comparative | HC11 | 9.5 | 3H | bad | 0.3 | 0.007 | 12.8 | 2.0 | 0.2 | 6.5 |
| Example 4 | | | | | | | | | | |

### Preparation Example 12

### Preparation of Conductive Compound Dispersion C

To 1,000 ml of a 2 mass % aqueous solution of polystyrenesulfonic acid (molecular weight: about a hundred thousand), 8.0 g of 3,4-ethylenedioxythiophene was added, and mixed into the solution at 20° C. To this mixture, 100 ml of an oxidation catalyst solution (containing 15 mass % of ammonium persulfate and 4.0 mass % of ferric sulfate) was added, and stirred for 3 hours at 20° C. to cause reaction therein.

To the reaction solution obtained, 1,000 ml of ion exchange water was added, and then an about 1,000 ml portion of the resulting solution was removed by ultrafiltration. This operation was repeated three times.

To the thus obtained solution, 100 ml of an aqueous sulfuric acid solution (10 mass %) and 1,000 ml of ion exchange water were added, and then an about 1,000 ml portion of the resulting solution was removed by ultrafiltration. To the thus obtained solution, 1,000 ml of ion exchange water was added, and then an about 1,000 ml portion of the resulting solution was removed by ultrafiltration. These operations were repeated 5 times. In this manner, an about 1.1 mass % of aqueous solution of PEDOT.PSS (poly(3,4-ethylenedioxythiophene).polystyrenesulfonic acid) was obtained. The solid concentration of this solution was adjusted to 1.0 mass % by addition of ion exchange water. Thus, a conductive compound solution (A) was prepared.

To a 200 ml portion of this aqueous solution (A), 200 ml of acetone was added, and then 210 ml of water-acetone mixture was removed by ultrafiltration. This operation was repeated again, and a 1.0 mass % water/acetone solution was prepared by controlling the solid concentration by addition of acetone. To a 200 ml portion of this solution, 500 ml of acetone in which 2.0 g of trioctylamine was dissolved was added, and stirred for 3 hours by means of a stirrer. From the resulting solution, 510 ml of water-acetone mixture was removed by ultrafiltration. The solid concentration was controlled by addition of acetone, and a 1.0 mass % of acetone solution was prepared as a conductive compound solution (B). The water content of this solution was 2 mass %.

To a 200 ml portion of this solution (B), 300 ml of methyl ethyl ketone was added, and mixed into the solution. The resulting solution was concentrated under reduced pressure at room temperature until the total amount thereof was reduced to 200 ml. To the solid content therein, an adjustment was made by use of methyl ethyl ketone, thereby preparing a 1.0 mass % of methyl ethyl ketone solution as the conductive compound dispersion C. The water content of this solution was 0.05 mass %, and the rate of remaining acetone was 1 mass % or below. The content of the conductive compound made up 50 mass % of the solid content of this solution.

### (Preparation of Coating Solution for Forming Antistatic Layer)

Various ingredients were mixed together as shown in Table 4, and dissolved into a solvent mixture of methyl ethyl ketone, IPA and a carbonate solvent. In this manner, coating solutions H12 to H14 having a solid concentration of 30 mass % were prepared for forming antistatic layers.

TABLE 4

| | Dispersion of | | | | | | | |
|---|---|---|---|---|---|---|---|---|
| | Conductive | | Multifunctional | | | | | |
| | Compound | | Monomer | | Initiator | | | |
| Coating | | Amount | | Amount | | Amount | Solvent for Dilution | |
| Solution | Variety | (mass %) | Species | (mass %) | Species | (mass %) | (mass %) | note |
| H12 | Dispersion C | 6 | DPHA | 91 | Irg.127 | 3 | PGM(25.5)/IPA(59.5)/DMC(15) | Invention |
| H13 | Dispersion C | 6 | DPHA | 91 | Irg.127 | 3 | PGM(25.5)/IPA(59.5)/DEC(15) | Invention |
| H14 | Dispersion C | 6 | DPHA | 91 | Irg.127 | 3 | PGM(30)/IPA(70) | Comparative |
| | | | | | | | | Example |

Optical films (Sample Nos. HC12 to HC14) were made in the same manner as the optical film of Sample No. HC1, except that the antistatic layers were formed on the cellulose triacetate film by coating the coating solutions H12 to H14, respectively.

Further, samples having received the chemical resistance testing were made from Sample Nos. HC12 to HC14 in the same manner as the sample having received the chemical resistance testing was made from Sample No. HC1.

### (Evaluation of Optical Film)

Various properties of each optical film were evaluated in accordance with the methods described above. Results obtained are shown in Table 5.

TABLE 5

| | | | | | | | | | | Properties |
|---|---|---|---|---|---|---|---|---|---|---|
| | | | | | | | | | | after |
| | | | | | | | | | | Chemical |
| | | Properties of Coating Solution Sample | | | | | | | | Resistance |
| | Sample | | Pencil | | | | | | | Testing |
| | No. | Conductivity | Hardness | Adhesiveness | Haze | Ra | α | β | α/β | ΔlogSR |
| Example 8 | HC12 | 7.9 | 3H | good | 0.2 | 0.005 | 1.5 | 7.1 | 4.7 | 0.1 |
| Example 9 | HC13 | 7.8 | 3H | good | 0.3 | 0.006 | 1.7 | 7.2 | 4.2 | 0.2 |
| Comparative | HC14 | 7.5 | 3H | bad | 0.2 | 0.005 | 11.8 | 1.2 | 0.1 | 7.2 |
| Example 4 | | | | | | | | | | |

A coating of Ln1 was applied directly to the present Samples Nos. HC2, HC3 and HC12, respectively, and cured by irradiation with UV rays of 600 ml/cm² to be formed into a 0.1 μm-thick low refractive-index layer. The thus made antireflection films had satisfactory antistatic properties and optical characteristics, what's more they showed no change in conductivity after chemical resistance testing.

As can be seen from the experimental results mentioned above, the invention can provide optical films having not only satisfactory conductivity, film strength and adhesiveness but also excellent chemical resistance.

1. An optical film comprising:
a cellulose acylate film; and
an antistatic layer including a conductive compound having a hydrophilic property,
wherein the conductive compound is localized in an inside of the antistatic layer as compared to a surface-side region of the antistatic layer.

2. The optical film according to claim 1, wherein the conductive compound is an ion-conducting compound or an electron-conducting compound.

3. The optical film according to claim 1, wherein the conductive compound is an ion-conducting compound having a quaternary ammonium base.

4. The optical film according to claim 3, wherein the compound having a quaternary ammonium base is a polymer having at least one of structural units represented by formulae (I) to (III): 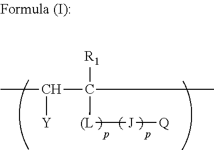
wherein R₁ represents a hydrogen atom, an alkyl group, a halogen atom or —CH₂COO⁻M⁺; Y represents a hydrogen atom or —COO⁻M⁺; M⁺ represents a proton or a cation; L represents —CONH—, —COO—, —CO— or —O—; J represents an alkylene group or an arylene group; each of p and q independently represents 0 or 1 and Q represents one selected from the following group 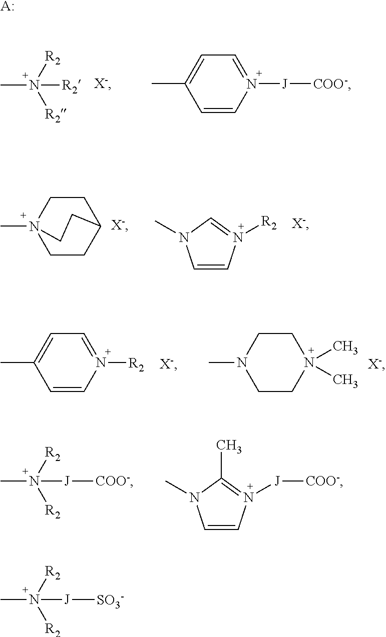
wherein each of R₂s, R₂′ and R₂″ independently represents an alkyl group; each J represents an alkylene group or an arylene group; and each X⁻ represents an anion, 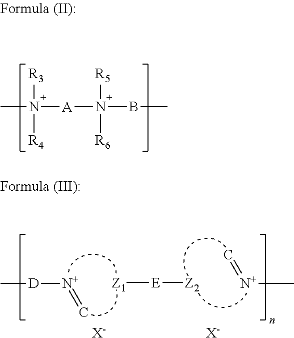
wherein each of R₃, R₄, R₅ and R₆ independently represents an alkyl group; R₃ and R₄ may bond to each other to form a nitrogen-containing heterocyclic ring and R₅ and R₆ may bond to each other to form a nitrogen-containing heterocyclic ring; each of A, B and D independently represents an alkylene group, an arylene group, an alkenylene group, an arylenealkylene group, —R₇COR₈—, —R₉COOR₁₀OCOR₁₁—, —R₁₂OCR₁₃COOR₁₄—, —R₁₅—(OR₁₆)ₘ—, —R₁₇CONHR₁₈NHCOR₁₉—, —R₂₀OCONHR₂₁NHCOR₂₂— or —R₂₃NHCONHR₂₄NHCONHR₂₅—; E represents a single bond, an alkylene group, an arylene group, an alkenylene group, an arylenealkylene group, —R₇COR₈—, —R₉COOR₁₀OCOR₁₁—, —R₁₂OCR₁₃COOR₁₄—, —R₁₅—(OR₁₆)ₘ—, —R₁₇CONHR₁₈NHCOR₁₉—, —R₂₀OCONHR₂₁NHCOR₂₂—, —R₂₃NHCONHR₂₄NHCONHR₂₅— or —NHCOR₂₆CONH—; each of R₇, R₈, R₉, R₁₁, R₁₂, R₁₄, R₁₅, R₁₆, R₁₇, R₁₉, R₂₀, R₂₂, R₂₃, R₂₅ and R₂₆ represents an alkylene group; each of R₁₀, R₁₃, R₁₈, R₂₁ and R₂₄ independently represents a linkage group selected from an alkylene group, an alkenylene group, an arylene group, an arylenealkylene group or an alkylenearylene group; m represents a positive integer of 1 to 4; X⁻ represents an anion; each of Z₁ and Z₂ represents nonmetal atoms required for forming a 5- or 6-membered ring together with the group —N═C—, which may link with E in a form of a quaternary salt ≡N⁺[X⁻]—; and n represents an integer of 5 to 300.

5. The optical film according to claim 3, wherein the antistatic layer has a nitrogen or sulfur atom content of 0.5 mol % to 5 mol % in the surface-side region, wherein the content is determined by elementary analysis by means of ESCA.

6. The optical film according to claim 3, characterized in that the antistatic layer has a nitrogen or sulfur atom content distribution satisfying expression (1), wherein the content is determined by elementary analysis by means of ESCA:
β/α>2.5 Expression (1):
wherein α and β are nitrogen or sulfur atom contents determined by the elementary analysis of the antistatic layer; and when a total nitrogen or sulfur atom content of the antistatic layer is taken as 100 mol %, α represents a nitrogen or sulfur atom content in the surface-side region of the antistatic layer and β represents a nitrogen or sulfur atom content in a cellulose acylate film-side region of the antistatic layer.

7. The optical film according to claim 1, which has a total haze of from 0.1% to lower than 1% and an arithmetic mean roughness Ra according to JIS B0601 of 0.03 μm.

8. The optical film according to claim 1, wherein the antistatic layer has a thickness of 6 μm to 20 μm.

9. The optical film according to claim 1, wherein the antistatic layer is a layer formed by curing a composition containing the conductive compound, a multifunctional monomer having two or more polymerizable groups, a photopolymerization initiator and a carbonate solvent represented by formula (IV) or (V): 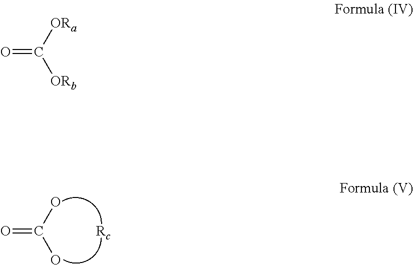
wherein each of Ra and Rb independently represents an alkyl group, and Rc represents an alkylene group.

10. The optical film according to claim 9, wherein the polymerizable group of the multifunctional monomer is a group selected from an acryloyl group, a methacryloyl group or —C(O)OCH═CH₂.

11. A method for producing an optical film including a cellulose acylate film and an antistatic layer, the method comprising:
coating on the cellulose acylate film a composition including a conductive compound having a hydrophilic property, a multifunctional monomer having two or more polymerizable groups, a photopolymerization initiator, and a carbonate solvent represented by formula (IV) or (V); and
curing the composition coated, to form the antistatic layer: 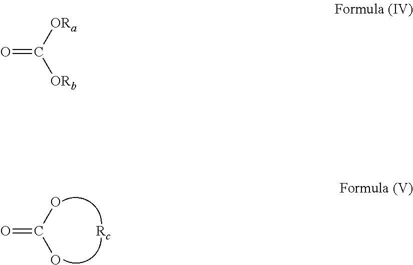
wherein each of Ra and Rb independently represents an alkyl group, and Rc represents an alkylene group.

12. The method according to claim 11, wherein the conductive compound is an ion-conducting compound or an electron-conductive compound.

13. The method according to claim 11, wherein the conductive compound is an ion-conducting compound having a quaternary ammonium base.

14. The method according to claim 13, wherein the compound having a quaternary ammonium base is a polymer having at least one of the structural units represented by the formulae (I) to (III): 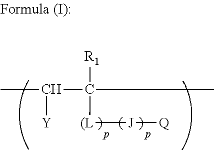
wherein R₁ represents a hydrogen atom, an alkyl group, a halogen atom or —CH₂COO⁻M⁺; Y represents a hydrogen atom or —COO⁻M⁺; M⁺ represents a proton or a cation; L represents —CONH—, —COO—, —CO— or —O—; J represents an alkylene group or an arylene group; each of p and q independently represents 0 or 1 and Q represents one selected from the following group 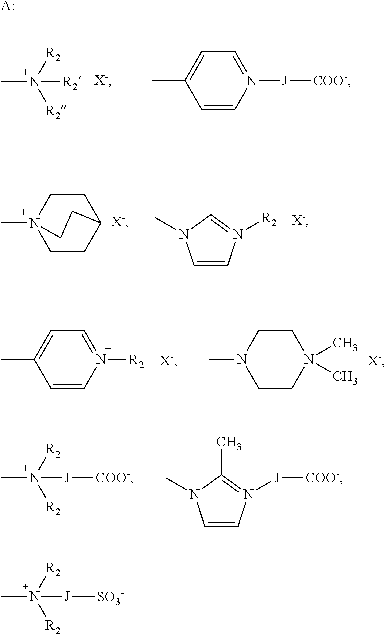
wherein each of R₂s, R₂′ and R₂″ independently represents an alkyl group; each J represents an alkylene group or an arylene group; and each X⁻ represents an anion, 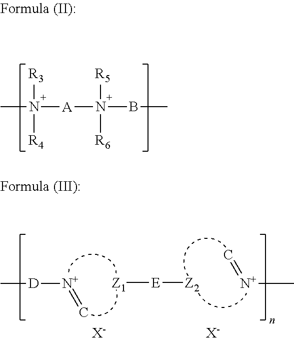
wherein each of R₃, R₄, R₅ and R₆ independently represents an alkyl group; R₃ and R₄ may bond to each other to form a nitrogen-containing heterocyclic ring and R₅ and R₆ may bond to each other to form a nitrogen-containing heterocyclic ring; each of A, B and D independently represents an alkylene group, an arylene group, an alkenylene group, an arylenealkylene group, —R₇COR₈—, —R₉COOR₁₀OCOR₁₁—, —R₁₂OCR₁₃COOR₁₄—, —R₁₅—(OR₁₆)ₘ—, —R₁₇CONHR₁₈NHCOR₁₉—, —R₂₀OCONHR₂₁NHCOR₂₂— or —R₂₃NHCONHR₂₄NHCONHR₂₅—; E represents a single bond, an alkylene group, an arylene group, an alkenylene group, an arylenealkylene group, —R₇COR₈—, —R₉COOR₁₀OCOR₁₁—, —R₁₂OCR₁₃COOR₁₄—, —R₁₅—(OR₁₆)ₘ—, —R₁₇CONHR₁₈NHCOR₁₉—, —R₂₀OCONHR₂₁NHCOR₂₂—, —R₂₃NHCONHR₂₄NHCONHR₂₅— or —NHCOR₂₆CONH—; each of R₇, R₈, R₉, R₁₁, R₁₂, R₁₄, R₁₅, R₁₆, R₁₇, R₁₉, R₂₀, R₂₂, R₂₃, R₂₅ and R₂₆ represents an alkylene group; each of R₁₀, R₁₃, R₁₈, R₂₁ and R₂₄ independently represents a linkage group selected from an alkylene group, an alkenylene group, an arylene group, an arylenealkylene group or an alkylenearylene group; m represents a positive integer of 1 to 4; X⁻ represents an anion; each of Z₁ and Z₂ represents nonmetal atoms required for forming a 5- or 6-membered ring together with the group —N═C—, which may link with E in a form of a quaternary salt ≡N⁺[X⁻]—; and n represents an integer of 5 to 300.

15. An antireflection film comprising:
an optical film comprising:
a cellulose acylate film; and
an antistatic layer including a conductive compound having a hydrophilic property,
wherein the conductive compound is localized in an inside of the antistatic layer as compared to a surface-side region of the antistatic layer; and
a low refractive-index layer having a lower refractive index than that of the antistatic layer.

16. A polarizing plate comprising:
a polarizer; and
two protective films on respective sides of the polarizer, wherein at least one of the two protective films is an optical film comprising:
a cellulose acylate film; and
an antistatic layer including a conductive compound having a hydrophilic property,
wherein the conductive compound is localized in an inside of the antistatic layer as compared to a surface-side region of the antistatic layer.

17. An image display apparatus comprising an optical film comprising:
a cellulose acylate film; and
an antistatic layer including a conductive compound having a hydrophilic property,
wherein the conductive compound is localized in an inside of the antistatic layer as compared to a surface-side region of the antistatic layer.
